(19) United States
(12) Patent Application Publication
(10) Pub. No.: US 2022/0343197 A1
(43) Pub. Date: Oct. 27, 2022

(54) SYSTEMS AND METHODS FOR PROVIDING MACHINE LEARNING MODEL EXPLAINABILITY INFORMATION

(71) Applicant: ZestFinance, Inc., Burbank, CA (US)

(72) Inventors: Douglas C. Merrill, Los Angeles, CA (US); Michael Edward Ruberry, Los Angeles, CA (US); Ozan Sayin, West Hollywood, CA (US); Bojan Tunguz, Greencastle, IN (US); Lin Song, Sugar Land, TX (US); Esfandiar Alizadeh, Venice, CA (US); Melanie Eunique DeBruin, Northridge, CA (US); Yachen Yan, Los Angeles, CA (US); Derek Wilcox, Los Angeles, CA (US); John Candido, Burbank, CA (US); Benjamin Anthony Solecki, Los Angeles, CA (US); Jiahuan He, Los Angeles, CA (US); Jerome Louis Budzik, Altadena, CA (US)

(73) Assignee: ZestFinance, Inc., Burbank, CA (US)

(21) Appl. No.: 17/812,093

(22) Filed: Jul. 12, 2022

Related U.S. Application Data
(62) Division of application No. 15/970,626, filed on May 3, 2018, now abandoned.
(60) Provisional application No. 62/501,574, filed on May 4, 2017.

(51) Int. Cl. G06N 5/04; G06N 20/00; G06N 20/20

(52) U.S. Cl. CPC G06N 5/045; G06N 20/00; G06N 20/20

(57) ABSTRACT

Systems and methods for generating explanation information for a result of an application system. Explanation configuration is generated based on received user input. Responsive to an explanation generation event, a plurality of modified input variable value sets are generated for a first applicant by using the explanation configuration. For each modified input variable value set: a request is provided to a first application system for generation of a result for the modified input variable value set, and a result is received for the modified input variable value set. At least one input variable value is selected based on a comparison between a first result of a first input variable value set of the first applicant and results for the modified input variable value set. Explanation information is generated for the first result by using human-readable description information for each selected input variable value, in accordance with the explanation configuration.

### CROSS-REFERENCE TO RELATED APPLICATIONS

This application is a divisional of U.S. patent application Ser. No. 15/970,626, filed on May 3, 2018, which claims the benefit of U.S. Provisional Application No. 62/501,574, filed on May 4, 2017, the entire content of which is hereby incorporated by reference.

### TECHNICAL FIELD

This disclosure relates generally to the machine learning field, and more specifically to new and useful systems and methods for explaining results generated by machine learning models.

### BACKGROUND

As complexity of machine learning systems increases, it becomes increasingly difficult to explain results generated by machine learning systems. While computer scientists understand the specific algorithms used in machine learning modelling, the field has generally been unable to provide useful explanations of how a particular model generated by anything but the simplest of algorithms works. This has limited their adoption by businesses seeking to solve high stakes problems which require transparency into a model's inner workings. Without transparency into how a machine learning model works, business stakeholders lack confidence in a model's ability to consistently meet business, legal and regulatory requirements. Business owners cannot determine whether a machine learning model will run amuck and create undue financial or reputational risk. This limitation is present in the most basic machine learning techniques such as neural networks, and it extends to many more advanced and complex methods such as, without limitation, multilayer perceptrons, and recurrent neural networks. This limitation of machine learning model explainability extends to ensembled models, including, without limitation, stacked and blended models, which combine the power of many modeling methods such as, regression models including logistic regression, tree models including classification and regression trees (CART), gradient boosted trees, ridge regression, factorization machines, including field-aware factorization machines, support vector machines, follow the regularized leader (FTRL), greedy step averaging (GSA), time-decaying adaptive prediction (TDAP), neural networks, multilayer perceptrons, recurrent nets, deep networks, and other methods, without limitation, which are combined to achieve more predictive power. There is a need in the machine learning field for new and useful systems for explaining results generated by machine learning models. There is no general way to better understand why a machine learning model made the prediction it did. The disclosure herein provides such new and useful systems and methods.

### BRIEF DESCRIPTION OF THE FIGURES

FIG. 1 is a schematic representation of a system, according to embodiments;

FIG. 2 is a schematic representation of a modeling system, according to embodiments;

FIG. 3A is a schematic representation of a modeling engine, according to embodiments;

FIG. 3B is a schematic representation of a modeling engine, according to embodiments;

FIG. 4 is a schematic representation of an explanation generator, according to embodiments;

FIG. 5 is a schematic representation of an explanation creation system, according to embodiments;

FIG. 6 is a diagram depicting system architecture of a system, according to embodiments;

FIG. 7 is a diagram depicting system architecture of an explanation system, according to embodiments;

FIG. 8 is a diagram depicting system architecture of an explanation generator system, according to embodiments;

FIG. 9 is a diagram depicting system architecture of an explanation creation system, according to embodiments;

FIG. 10 is a diagram depicting system architecture of a modeling system, according to embodiments;

FIG. 11 is a diagram depicting system architecture of a single scorer system, according to embodiments;

FIG. 12 is a diagram depicting system architecture of an ensembled scorer system, according to embodiments:

FIG. 13 is a diagram depicting system architecture of a ensembler system, according to embodiments;

FIG. 14 is a representation of a method, according to embodiments; and

FIGS. 15A-B are schematic representations of systems, according to embodiments;

FIG. 16 is a representation of a method, according to embodiments;

FIG. 17 is a representation of a method, according to embodiments;

FIG. 18 is a representation of a method, according to embodiments;

FIG. 19 is a representation of a method, according to embodiments;

FIG. 20 is a representation of a method, according to embodiments; and

FIG. 21 is a diagram depicting system architecture of a system, according to embodiments.

### DESCRIPTION OF EMBODIMENTS

The following description of embodiments is not intended to limit the disclosure to these embodiments, but rather to enable any person skilled in the art to make and use the embodiments disclosed herein.

### 0. Overview

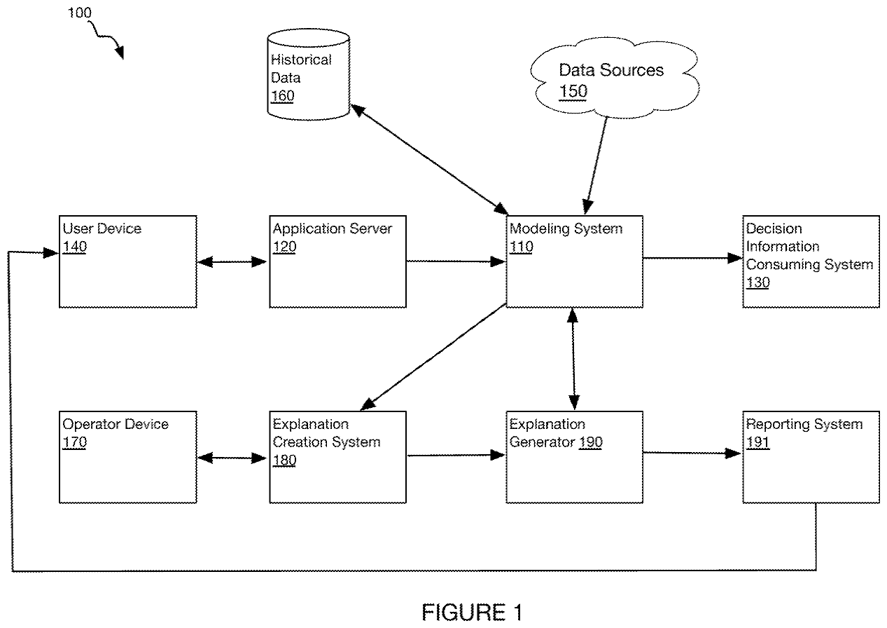

An explanation generator for a modeling system and related methods for generating explanation information for a modeling system are provided. In some embodiments, the explanation generator (e.g., 190 of FIG. 1) is constructed to communicatively couple to a modeling system (e.g., 110) (e.g., via an API). The modeling system receives a first set of input variable values for a first data set (e.g., a data set of a user, such as a loan applicant, a patient, and the like) and generates a first score for the input variable values. (In some embodiments, the first set of input variable values is represented as a set of key-value pairs with the key being the variable identifier and the value being the variable value. In some embodiments, the first set of input variable values is represented as an array of variable values, with each position in the array corresponding to a particular variable.) The explanation generator accesses the first set of input variable values (original values), and the first score (original score), generates at least a first modified set of input variable values, provides each modified set of input variable values to the modeling system, receives a modified score for each modified set of input variable values from the modeling system, and generates human-readable explanation information based on the original score, the modified scores and corresponding original and modified sets of input variable values.

In some embodiments, the explanation generator (e.g., 190) generates modified sets of input variable values by accessing user selection of a set of variables of the first set of input variables to be modified individually, and generating at least one modified set of input variable values for each variable of the set of selected variables, wherein each modified set includes the original input variable values with the exception of the modified value for the selected variable. In some embodiments, the explanation generator determines a number of modified sets of input variable values to be generated for a selected variable, and variable values of the selected variable for each modified set, based on transformation information. In some embodiments, the transformation information is user-specified transformation information provided by to the explanation generator via an operator device (e.g., 170). In some embodiments, the transformation information includes instructions to apply transformations such as variable normalization, scaling, PCA/ICA, missing imputation, derivations of new features (feature engineering), encoding, embeddings, bucketing, binning, or algorithmic transformations, including the application of any mathematical, computational or hashing function, resulting in the replacement or deletion of an input value based on the original value and the value of each input variable, the original score and the distribution of data.

In some embodiments, the explanation generator (e.g., 190) generates modified sets of input variable values by accessing user selection of a set of groups of variables to be modified in combination with each other, and generating at least one modified set of input variable values for each group of variables of the set of selected groups of variables, wherein each modified set includes the original input variable values with the exception of the modified values for the variable of the selected group.

In some embodiments, the explanation generator determines a number of modified sets of input variable values to be generated for a selected group of variables, and variable values for the selected group of variables for each modified set, based on transformation information. In some embodiments, the transformation information is user-specified transformation information provided by to the explanation generator via an operator device (e.g., 170).

In some embodiments, the explanation generator precomputes explanations based on predetermined selection criteria, including without limitation, a set of values of an input variable, a set of values of a combined variable computed based on input variables within a group of input variables, permutations or combinations of subsets of input variables, and permutations or combinations of subsets of a computed variable based on the input variables within an input variable groups. In some embodiments, these precomputed explanations are generated via methods such as grid search, executed using optimization methods such as dynamic programming, on a single or networked cluster of compute nodes, without limitation. In some embodiments, the precomputed explanations are stored in the form of a hash table or tree so as to facilitate lookup by the explanation generator 190.

In some embodiments, the explanation generator (e.g., 190) generates the human-readable explanation information as follows: the explanation generator compares a modified score with the first score (original score); if a) the comparison indicates that the modified score is greater than the original score, and b) one of the modified score, a corresponding variable, and a corresponding variable value satisfies selection criteria, then the explanation generator accesses description information stored in association with the corresponding variable value and generates the explanation information based on the accessed description information. In some embodiments, each input variable is transformed and the modified score computed; the difference between the original score and the modified score is computed; the top n explanations are retained for transmission to the user, where n is a tunable parameter set via an operator device (e.g., 170) or by computation based on the distribution of score differences among variables for the instant application and the distribution of score differences among prior applicants or application models. In some embodiments, the selection criteria is user-specified selection criteria provided to the explanation generator via an operator device (e.g., 170). In some embodiments the selection criteria is determined by a statistical property of the score differences. In some embodiments, the description information is user-specified description information provided to the explanation generator via an operator device (e.g., 170). In other embodiments, the description information is generated automatically by using templates or rules, such as, e.g., production rules, such as <variable name> was too {high, low}.

In some embodiments, the explanation information indicates a possible or actual cause for the first score generated by the modeling system for the first set of input variable values. In some embodiments, the explanation information indicates actions that can be taken to increase a score generated by the modeling system relative to the first score generated for the first set of input variable values.

In some embodiments, the explanation generator receives user selection of a set of variables of the first set of input variables to be modified individually, user selection of a set of groups of variables to be modified in combination with each other, user-specified transformation information, user-specified selection criteria, and user-specified description information from an explanation creation system (e.g., 180) that is communicatively coupled to an operator device (e.g., 170).

In some embodiments, the explanation creation system (e.g., 180) is constructed to control the operator device to present to the operator historical sets of input variable values (and corresponding variable identifiers) along with respective scores generated by the modeling system (e.g., 110). In this manner, an operator viewing the historical data (sets of variable values, with corresponding variable names and scores) can identify impactful variables (or groups of variables) whose changes (individually or in combination with other variables) are likely to result in a higher score from the modeling system, and identify values for those impactful variables (or groups of variables) that are likely to contribute to a higher score. In some embodiments, the explanation creation system is constructed to control the operator device to present to the operator impactful variables (or groups of variables) (identified by the explanation creation system) whose changes (individually or in combination with other variables) are likely to result in a higher score from the modeling system, and values for those impactful variables (or groups of variables) (identified by the explanation creation system) that are likely to contribute to a higher score.

In some embodiments, the explanation creation system (e.g., 180) is constructed to control an operator device (e.g., 170) to present the operator visualizations of each input variable in the form of a partial dependence plot. In some embodiments, the explanation creation system 180 is constructed to allow the operator to highlight regions of the input variable to determine good and bad ranges. In other embodiments, the explanation creation system 180 causes the operator device 170 to automatically highlight breaks in the continuous variable distribution based on statistical properties of the continuous variable or other analysis of input variable values.

In some embodiments, the operator specifies the user selection of a set of variables of the first set of input variables to be modified individually, the user selection of a set of groups of variables to be modified in combination with each other, and the user-specified transformation information based on the identified impactful variables (or groups of variables) and the identified impactful variable values.

In some embodiments, the operator specifies the user-specified description information for an impactful variable to include a textual explanation for a first score (original score) generated by the modeling system; the description information is used to generate explanation information in a case where a modified set of input variables having a modified value for the impactful variable satisfies the user-specified selection criteria specified by the operator. For example, if an operator believes that a certain variable value results in a high score from the modeling system, then the operator can specify description information for this variable-value combination that explains that a score is low because it does not include the variable value.

As a first example, a loan applicant applies for a loan, the first data set is data collected for the loan applicant (e.g., from credit bureaus, third party data providers, applicant-provided data, and the like), the first set of input variable values are values derived from the first data set, and the score indicates likelihood of the loan applicant defaulting on a loan. In the first example, the explanation generated by the explanation generator could indicate reasons for a loan application getting denied. In the first example, the explanation could indicate actions that can be take by the loan applicant to increase their likelihood of getting approved for a loan. In some embodiments, the explanation indicates recommendations. In some embodiments, the explanation indicates the values of internal states used to determine a score. In some embodiments, the explanation indicates a history of values and internal states. In some embodiments, the explanation indicates the value of variables retrieved from external data sources. In some embodiments, the explanation is designed based on rules, guidelines, best practices or regulations imposed by government entities such as government agencies, states, municipalities, sovereign nations, or independent government agencies. In some embodiments the explanation includes statements that describe the reasons for a credit decision to a consumer who has applied for a credit card or personal loan. In some embodiments the explanation includes statements that describe reasons for a credit denial decision that a consumer might correct by taking specific and tangible actions. In other embodiments, the explanation is designed based on business policies, legal policies, and risk policies.

As a second example, the first data set is data collected for a patient (e.g., from medical tests, third party data providers, patient-provided data, patient medical history data, and the like), the first set of input variable values are values derived from the first data set, and the score indicates likelihood of a particular diagnosis for a patient. In the second example, the explanation generated by the explanation generator could indicate possible causes for a particular diagnosis. In the second example, the explanation generated by the explanation generator could include information explaining to a patient how to improve their health. In some embodiments the explanation includes multimedia content such as images and diagrams, audio clips, written descriptions, howtos, and video content including coaching videos, all of which may be personalized to the specific patient, their diagnosis, and the specific reasons for their diagnosis.

In some embodiments, the explanation generator is constructed as a system external to the modeling system, and the explanation generator system provides input variable values to the modeling system as if it were a data source, and receives scores from the modeling system as if it were a consuming system for scores generated by the modeling system. In some embodiments, the explanation generator system is constructed to emulate a data provider of the modeling system and emulate a score consumer of the modeling system. By virtue of the foregoing, explanation for scores generated by a modeling system can be provided without modifying the modeling system.

### 1. Systems

FIG. 1 is a schematic representation of a system, according to embodiments.

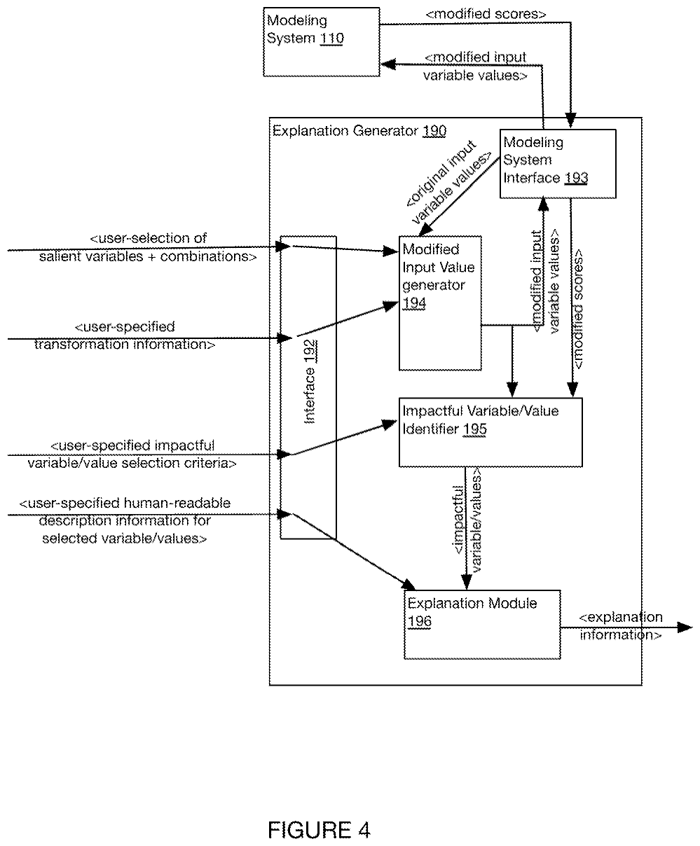

In some embodiments, the Explanation Generator 190 is constructed to generate explanation information for a scored set of input variable values. More specifically the Explanation Generator 190 is constructed to receive a set of input variable values (and corresponding variable identifiers) for a first data set, and a score generated by the modeling system 110 for the set of input variable values; the Explanation Generator 190 is constructed to provide at least one modified set of input variable values to the modeling system 110 and receive at least one modified score (for the at least one modified set of input variable values provided to the modeling system 110) from the modeling system 110. In some embodiments, the Explanation Generator 190 is constructed to receive the set of input variable values (and corresponding variable identifiers) for the first data set, and the score, from the modeling system 110 via an API (Application Program Interface) (e.g., an API of the interface 193 of FIG. 4), the Explanation Generator 190 is constructed to provide the at least one modified set of input variable values to the modeling system 110 via the API, and the Explanation Generator 190 is constructed to receive the at least one modified score from the modeling system 110 via the API. In some embodiments, the API is an API of the modeling system 110. In some embodiments, the API is an API of the explanation generator 110. In some embodiments, the API is a public API that is accessible via the Internet. In some embodiments, the API is a private API. In some embodiments, the API includes one or more of a RESTful API, EDI, CORBA, XMLRPC, and other machine to machine communication methods and programming interfaces. In some embodiments, the API is an HTTP-based API. In some embodiments, the modeling system 110 is a system operated by a first entity, and the explanation generator 190 is a system operated by a different, second entity. As an example, a first entity operates the modeling system 110, and the modeling system 110 is communicatively coupled to the explanation generator 190, which is operated by a second entity, wherein the first entity is a business that uses the modeling system 110 to generate information used to make decisions, and the second entity provides a machine learning model explainability service. In some embodiments, the explanation generator 190 is an on-premises system that is co-located with the modeling system 110. In some embodiments, the explanation generator 190 is an off-premises system that is communicatively coupled to the modeling system 110 via the Internet. In some embodiments, the explanation generator 190 is an off-premises system that is communicatively coupled to the modeling system 110 via a private network (e.g., a VPN). In some embodiments, the explanation generator 190 is a multi-tenant explanation generator 190. In some embodiments, the explanation generator 190 is included in a multi-tenant machine learning model explainability platform.

In some embodiments, the explanation generator and the modeling system are operated by a same entity, and the modeling system includes at least one model generated by a second entity. In some embodiments, the explanation generator and the modeling system are included in a machine learning platform system operated by a same entity. In some embodiments, the explanation generator and the modeling system are included in a multi-tenant machine learning platform system operated by a same entity (e.g., a PaaS provider) and the modeling system includes at least one model generated by a second entity (e.g., an entity associated with a platform account of the platform system). In some embodiments, the second entity provides the at least one model to the multi-tenant machine learning platform system via an API. In some embodiments, the API is similar to the API described above.

In some embodiments, the system 100 includes: an explanation creation system 180 and an explanation generator 190. In some embodiments, the explanation generator 190 is communicatively coupled a modeling system 110. In some embodiments, the explanation creation engine 180 is communicatively coupled to the explanation generator 190. In some embodiments, the explanation creation engine 180 is communicatively coupled to the modeling system 110.

In some embodiments, the system 100 includes the modeling system 110.

In some embodiments, the modeling system is communicatively coupled to an application server 120. In some embodiments, the modeling system is communicatively coupled to a decision information consuming system 130. In some embodiments, the modeling system is communicatively coupled to the explanation creation system 180.

In some embodiments, the modeling system is communicatively coupled to the explanation generator 190.

In some embodiments, the modeling system is communicatively coupled to a data store 160 that stores historical data used by the modeling system. In some embodiments, the modeling system is communicatively coupled to one or more data provider systems (e.g., data sources 150).

In some embodiments, the application server 120 is communicatively coupled to a user device (e.g., a user device used by an applicant providing application data to be used by the modeling system 110).

In some embodiments, the explanation creation system 180 is communicatively coupled to the explanation generator 190.

In some embodiments, the explanation creation system 180 is communicatively coupled to an operator device (e.g., 170).

In some embodiments, the explanation generator 190 is communicatively coupled to a reporting system (e.g., 191). In some embodiments, the reporting system 190 is communicatively coupled to the user device via a network (e.g., the Internet, a telephony network, and the like).

In some embodiments, the explanation generator 190 is communicatively coupled to a CRM system (not shown). In some embodiments, the CRM system is communicatively coupled to the user device (e.g., 140) via a network (e.g., the Internet, a telephony network, and the like).

Explanation Generator

FIG. 4 is a schematic representation of an explanation generator, according to embodiments.

In some embodiments, the Explanation Generator 190 is constructed to generate explanation information for a scored set of input variable values. More specifically the Explanation Generator 190 is constructed to receive a set of input variable values (and corresponding variable identifiers) for a first data set, and a score generated by the modeling system 110 for the set of input variable values.

In some embodiments, the explanation generator 190 includes a modeling system interface 193 constructed for communication with the modeling system 110. In some embodiments, the explanation generator 190 includes an interface 192 constructed to receive user-selection of variables and combinations of variables, user selection of transformation information, user-specified impactful variable selection criteria, user-specified variable value selection criteria, user-specified human-readable description information for selected variables, and user-specified human-readable description information for selected variable values (e.g., from a an operator device 170, an explanation creation system 180). In some embodiments, the explanation generator 190 includes an interface 192 that is constructed to receive machine-selected variables and machine-selected combinations of variables, machine-generated transformation information, machine-generated impactful variable selection criteria, machine-generated variable value selection criteria, machine-generated human-readable description information for selected variables, and machine-generated human-readable description information for selected variable values (e.g., from a an explanation creation system 180). In some embodiments, the explanation generator 190 includes a modified input value generator 194 that is constructed to receive an original set of input variable values, generate at least one set of modified input values based on the received user-selection of variables and combinations of variables, and the received user specified transformation information, and provide each generated set of modified input values to the modeling system 110 (via the modeling system interface 193) for scoring.

In some embodiments, the explanation generator 190 includes an impactful variable/value identifier 195 that is constructed to receive the original score for the original input variable values from the modeling system via the interface 193, receive modified scores for each scored set of modified input variable values from the modeling system (via the interface 193), receive each modified set of input variable values from the modified input value generator 194, and identify one or more impactful variables and/or one or impactful variable values. In some embodiments, the identifier 195 is constructed to identify the one or more impactful variables and/or the one or impactful variable values by comparing each modified score (for a changed variable or group of variables in the corresponding modified set) with the original score, and selecting a changed variable (or group of variables) based on the user-specified impactful variable selection criteria and/or the user-specified variable value selection criteria. The identifier module 195 is constructed to provide information specifying each identified impactful variable and each identified impactful variable value to the explanation module 196.

In some embodiments, the explanation module 196 is constructed to receive the human-readable description information for selected variables (and groups of variables) and human-readable description information for selected variable values and store the explanation information in association with the corresponding variable (or group of variables)(and variable value if specified). In some embodiments, the explanation module 196 is constructed to access description information for each variable value and each variable specified by the identifier 195, and generate the output explanation information for the original input variable values and the corresponding original score based on the accessed description information. In some embodiments, the explanation module 196 includes a natural language processing (NLP) module that is constructed to process the accessed description information to generate the output generation information. In some embodiments, the explanation module 196 is constructed to provide the generated output explanation information to a reporting system (e.g., 191) via a reporting system interface.

In some embodiments, the explanation module 196 is constructed to provide the generated output explanation information to a user device (e.g., 140) via a user device interface. In some embodiments, the explanation module 196 is constructed to provide the generated output explanation information to a customer relationship management system. In some embodiments, the explanation module 196 is constructed to provide the generated output explanation information to a mailing system, causing a letter containing the machine generated explanations for a model-based decision to be sent to an applicant's home address.

Explanation Creation System

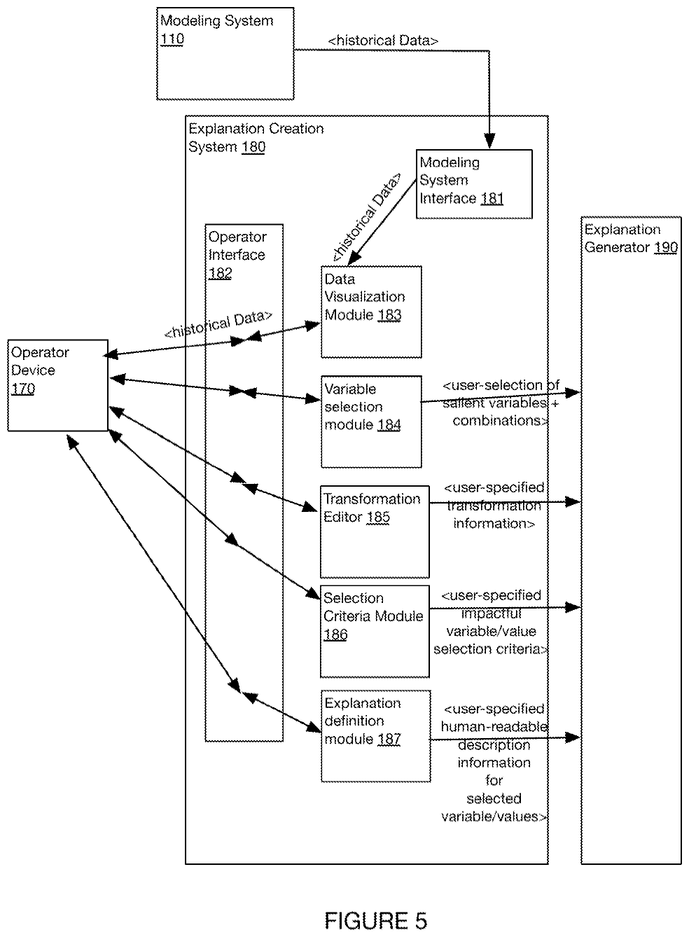

FIG. 5 is a schematic representation of an explanation creation system, according to embodiments.

In some embodiments, the explanation creation system 180 includes a modeling system interface 181 (e.g., an interface similar to interface 191 of FIG. 4).

In some embodiments, the explanation creation system 180 includes an operator interface 182 that is constructed to communicatively couple to an operator device (e.g., 170).

In some embodiments, the explanation creation system 180 includes a data visualization module 183 that is constructed to receive historical variable and variable value data (and scores) for previously scored sets of input variable values from the modeling system 110 via the interface 181 and provide the historical data to the operator device 170 (via the interface 182). In some embodiments, the data visualization module 183 produces partial dependence plots, heat maps, scatter plots, and histograms.

In some embodiments, the explanation creation system 180 includes a variable selection module 184 that is constructed to receive the user-selection of variables and combinations of variables via the interface 182 and provide the user-selection of variables and combinations of variables to the explanation generator 190. In some embodiments, the explanation creation system 180 includes a variable selection module 184 that presents the user with recommendations or templates to construct explanations, in some embodiments via an explanation creation wizard, which guides the user through a step by step process wherein the system receives user-selection of variables and combinations of variables via the interface 182 in a number of structured steps to provide the user-selection of variables and combinations of variables to the explanation generator 190.

In some embodiments, the explanation creation system 180 includes a transformation editor 185 that is constructed to receive the user selection of transformation information via the interface 182 and provide the user selection of transformation information to the explanation generator 190. In some embodiments, the explanation creation system 180 recommends values for transformations based on the distribution of variable values within a population. In some embodiments the population is determined by a statistical algorithm, including, without limitation, population sampling, unsupervised methods such as principal components analysis, factor analysis, k-means and other clustering analysis, t-sne, latent and quadratic dirichlet allocation, outlier and anomaly detection, and supervised classification and regression methods such as decision trees, random forest, gradient boosted trees, neural networks, regularized regression, support vector machines, bayesian classifiers, k-nearest neighbors, Follow the regularized leader, greedy step averaging (GSA), time-decaying adaptive prediction (TDAP), factorization machines, gaussian processes and online learning algorithms. In some embodiments the transformations are machine generated using unsupervised, supervised, and semi-supervised (human in the loop) methods.

In some embodiments, the explanation creation system 180 includes a selection criteria module 186 that is constructed to receive the user-specified impactful variable selection criteria and the user-specified variable value selection criteria via the interface 182 and provide the user-specified impactful variable selection criteria and the user-specified variable value selection criteria to the explanation generator 190. In some embodiments, the selection criteria module 186 recommends values for selection criteria based on the distribution of values within a population. In some embodiments the population is determined by a statistical algorithm, including, without limitation, population sampling, unsupervised methods such as principal components analysis, factor analysis, k-means and other clustering analysis, t-sne, latent and quadratic dirichlet allocation, outlier and anomaly detection, and supervised classification and regression methods such as decision trees, random forest, gradient boosted trees, neural networks, regularized regression, support vector machines, bayesian classifiers, k-nearest neighbors, Follow the regularized leader, greedy step averaging (GSA), time-decaying adaptive prediction (TDAP), factorization machines, gaussian processes and online learning algorithms. In some embodiments the transformations are machine generated using unsupervised, supervised, and semi-supervised (human in the loop) methods.

In some embodiments, the explanation creation system 180 includes an explanation definition module 187 that is constructed to receive the user-specified human-readable description information for selected variables and the user-specified human-readable description information for selected variable values via the interface 182 and provide the user-specified human-readable description information for selected variables and the user-specified human-readable description information for selected variable values to the explanation generator 190. In some embodiments, the explanation definition module 187 is constructed to receive a user-specified template selected from a plurality of templates, wherein a template executes rules to generate human-readable description information for each variable. In some embodiments, the explanation definition module 187 is constructed based on an automated process.

Modeling System

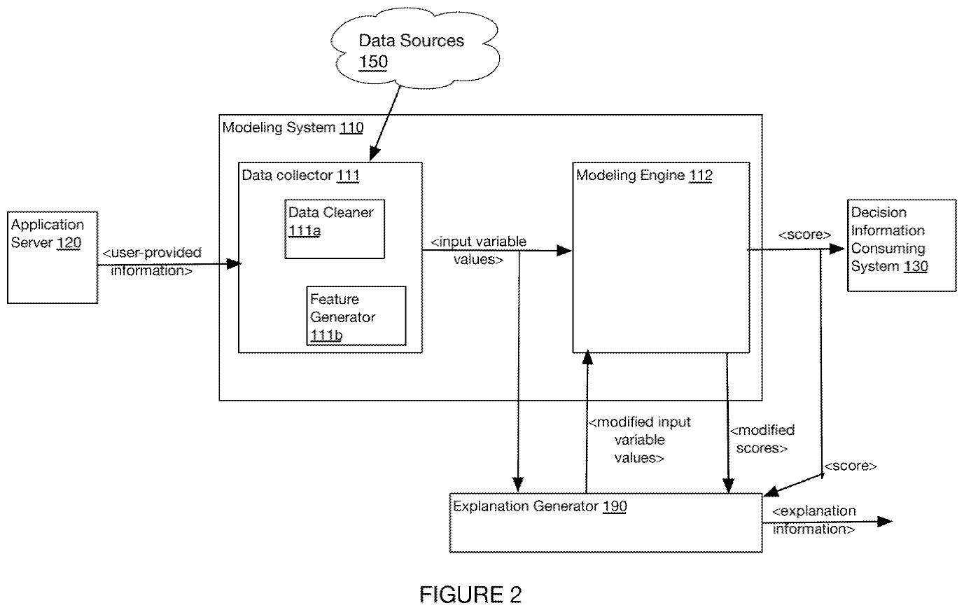

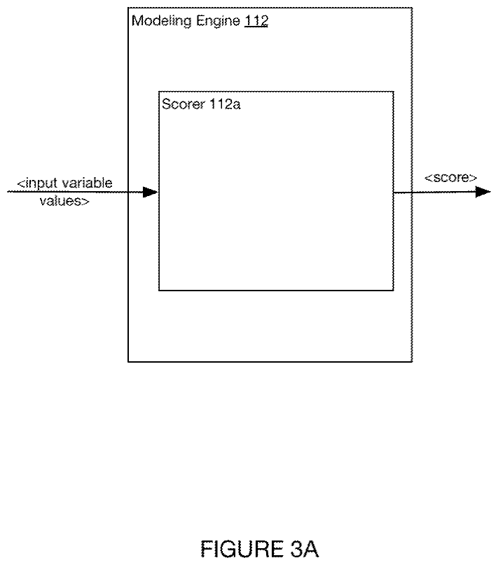

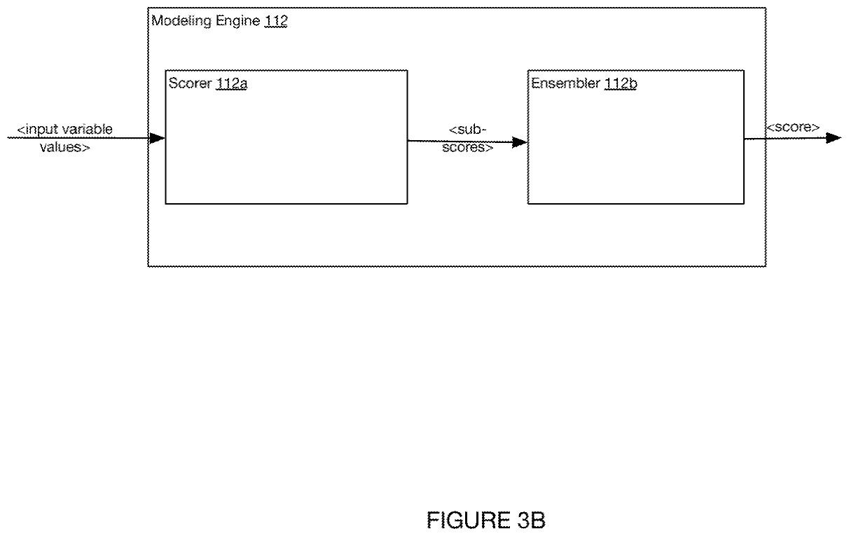

FIG. 2 is a schematic representation of a modeling system, according to embodiments. FIG. 3A is a schematic representation of a single scorer modeling engine, according to embodiments. FIG. 3B is a schematic representation of an ensembled modeling engine with multiple scoring modules, according to embodiments.

In some embodiments, the modeling system 110 is a modeling system that uses one of the following types of algorithms: population sampling, unsupervised methods such as principal components analysis, factor analysis, k-means and other clustering analysis, t-sne, latent and quadratic dirichlet allocation, outlier and anomaly detection, and supervised classification and regression methods such as decision trees, random forest, gradient boosted trees, neural networks, regularized regression, support vector machines, bayesian classifiers, k-nearest neighbors, Follow the regularized leader, greedy step averaging (GSA), time-decaying adaptive prediction (TDAP), factorization machines, gaussian processes, and online learning.

In some embodiments, the modeling system 110 is a neural-network modeling system.

In some embodiments, the modeling system 110 is an XGBoost modeling system.

In some embodiments, the modeling system 110 is a follow the regularized leader (FTRL) modeling system.

In some embodiments, the modeling system 110 is a regression model such as logistic regression, linear regression, and ridge regression.

In some embodiments, the modeling system 110 is a tree model such as classification and regression trees (CART), gradient boosted trees, random forests

In some embodiments, the modeling system 110 is a factorization machine, such as a field-aware factorization machine

In some embodiments, the modeling system 110 is a support vector machine

In some embodiments, the modeling system 110 uses follow the regularized leader (FTRL)

In some embodiments, the modeling system 110 uses greedy step averaging (GSA), time-decaying adaptive prediction (TDAP)

In some embodiments, the modeling system 110 is a neural network, such as a multilayer perceptron, recurrent net, or deep network

In some embodiments, the modeling system 110 is Random Forest modeling system.

In some embodiments, the modeling system 110 is a Boosted linear modeling system.

In some embodiments, the modeling system 110 is a Ensemble modeling system which is built upon one or more of submodels of any type.

In some embodiments, the modeling system 110 is constructed to receive values of discrete variables. In some embodiments, the modeling system 110 is constructed to receive values of continuous variables. In some embodiments, the modeling system 110 automatically refits its models by using recent data based on a user-selectable schedule. In other embodiments the modeling system 110, automatically refits its models by using recent data based on a schedule determined by a statistical method.

In some embodiments, the modeling system 110 is constructed to receive integer variable values. In some embodiments, the modeling system 110 is constructed to receive floating point variable values. In some embodiments, the modeling system 110 is constructed to receive character variable values. In some embodiments, the modeling system 110 is constructed to receive string variable values. In some embodiments, the modeling system 110 is constructed to receive vectors. In some embodiments, the modeling system 110 is constructed to receive matrices. In some embodiments, the modeling system 110 is constructed to receive images. In some embodiments, the modeling system 110 is constructed to receive sounds. In some embodiments, the modeling system 110 is constructed to receive web browsing histories. In some embodiments, the modeling system 110 is constructed to receive search histories. In some embodiments, the modeling system 110 is constructed to receive financial data, including, without limitation: credit bureau data, including, credit score, credit utilization history, default history, delinquency history, law enforcement history; transaction histories, including purchase histories, payment histories; and other data sources that may be acquired through a credit reporting agency or any third party. In some embodiments, the modeling system 110 is constructed to receive data collected by a data collection module which may collect data via methods such as a beacon or pixel, a directed web crawl, search, or lookup in a database. In some embodiments, the modeling system 110 is constructed to receive social media data, including, without limitation: a facebook profile, a twitter history, linkedin profile, a news feed, a publication history, and other social media sources.

In some embodiments, the modeling system 110 includes a modeling engine (e.g, 112 of FIG. 2). In some embodiments, the modeling system 110 includes a data collector (e.g, 111 of FIG. 2). In some embodiments, the data collector 111 includes a data cleaner 111a. In some embodiments, the data collector 111 includes a feature generator 111b. In some embodiments, the data collector 111 includes a scraper. In some embodiments, the data collector 111 includes a crawler and a search engine. In some embodiments, the data collector 111 includes a query generator and a query execution engine for collecting data from external sources such as databases and search engines. In some embodiments, the data collector 111 includes user provisioning and credential management. In some embodiments, the data collector 111 executes predetermined plans for gathering information that include variable substitution, recursion, and branching. In some embodiments, the feature generator 111b performs feature transformations including, without limitation: substitution, imputation, anomaly/outlier detection, maximum entropy, collinearity clustering, normalization, convolution, projection, dimensionality reduction, scaling, mapping, production rules such as those that can be expressed in Backus-Naur form, algebraic transformations, statistical transformations, and transformations based on the transmission of the input data to an external system via a computer network and the reception of the transformed data in a predetermined format.

Data Collector 111

In some embodiments, the data collector is constructed to receive user-provided information (e.g., loan application information) from one of a user device (e.g., 140) and an application server (e.g., 120) and access data from one or more data sources (e.g., 150) by using the user-provided information. In some embodiments, a data source includes a credit bureau system. In some embodiments, a data source includes web browsing or ecommerce data gathered by a data aggregator or collected by a publisher or ecommerce site. In some embodiments, a data source includes transactions data including purchases and payments provided by a financial services company such as a bank or credit card issuer.

In some embodiments, the data collector is constructed to generate a set of input variable values based on the data accessed from the one or more data sources. In some embodiments, the set of input variable values is a set of key-value pairs that includes a variable identifier as a key and a variable value as the value. In some embodiments, the input variables are encoded based on a delimited format.

In some embodiments, a data cleaner (e.g., 111a) is constructed to process raw data to generate processed data. In some embodiments, the data collector is constructed to generate the set of input variable values based on the processed data.

In some embodiments, a feature generator (e.g., 111b) is constructed to generate the input variables and corresponding values from the processed data provided by the data cleaner (e.g., 111a).

Modeling Engine 112

In some embodiments, the modeling engine 112 includes a scorer 112a (FIG. 3A). In some embodiments, the modeling engine 112 includes an ensembler 112b (FIG. 3B).

In some embodiments, the modeling engine 112 is a modeling engine that is constructed to use a machine learning modeling algorithm such as: population sampling, unsupervised methods such as principal components analysis, factor analysis, k-means and other clustering analysis, t-sne, latent and quadratic dirichlet allocation, outlier and anomaly detection, and supervised classification and regression methods such as decision trees, random forest, gradient boosted trees, neural networks, regularized regression, support vector machines, bayesian classifiers, k-nearest neighbors, Follow the regularized leader, greedy step averaging (GSA), time-decaying adaptive prediction (TDAP), factorization machines, gaussian processes, ensembling methods, and online learning.

In some embodiments, the modeling engine 112 is constructed to receive values of discrete variables. In some embodiments, the modeling engine 112 is constructed to receive values of continuous variables. In some embodiments, the modeling engine 112 is constructed to receive integer variable values. In some embodiments, the modeling engine 112 is constructed to receive floating point variable values. In some embodiments, the modeling engine 112 is constructed to receive character variable values. In some embodiments, the modeling engine 112 is constructed to receive string variable values. In some embodiments, the modeling engine 112 is constructed to receive a vector. In some embodiments, the modeling engine 112 is constructed to receive a matrix or vector of matrices. In some embodiments the modeling engine 112 is constructed to receive an image. In some embodiments the modeling engine 112 is constructed to receive a sound.

In some embodiments, the scorer 112a includes a plurality of scoring modules. In some embodiments, the plurality of scoring module include one or more of tree models, regression models, linear models, neural network models, and factorization machines. In some embodiments, the plurality of scoring module include two or more of tree models, regression models, linear models, neural network models, and factorization machines.

In some embodiments, the scorer 112a includes a single scoring modules that is constructed to generate a score for a set of input variable values (FIG. 3A). In some embodiments, the scorer 112a includes a plurality of scoring modules that are each constructed to generate a sub-score for at least a subset of input variable values, and each sub-score is provided to an ensembler (e.g., 112b) that generates an ensembled score that is provided to a decisioning information consuming system (e.g, 130) (FIG. 3B). In some embodiments the ensembler is built via stacking or blending or both, and other combinations of ensembling methods, without limitation, where model weights are determined based on the execution of a machine learning model, or are based on tunable parameters which may be set by the operator, determined based on computed mapping, or determined by automated processes such as grid-search, Bayesian optimization, randomized grid search. In some embodiments, the model weights are determined based on execution a machine learning model that uses at least one of the following types of algorithms: population sampling, unsupervised methods such as principal components analysis, factor analysis, k-means and other clustering analysis, t-sne, latent and quadratic dirichlet allocation, outlier and anomaly detection, and supervised classification and regression methods such as decision trees, random forest, gradient boosted trees, neural networks, regularized regression, support vector machines, bayesian classifiers, k-nearest neighbors, Follow the regularized leader, greedy step averaging (GSA), time-decaying adaptive prediction (TDAP), factorization machines, gaussian processes and online learning algorithms.

In other embodiments, the scoring system is executed via a data processing system comprised of multiple data processing nodes connected by a computer network, configured for parallel ensemble execution, wherein each computing node executes a subset of the sub-scores, so as to reduce the time required to compute an ensembled score. In other embodiments, the scoring system is constructed of multiple ensembles of models, a selector determines which model to use based on the input variables according to predetermined rules, and returns the score from the selected ensemble and its submodels. In other embodiments the scoring system is executed via map-reduce. In other embodiments the scoring system is deployed via distributed networks so as to provide increased capacity and fault-tolerance.

In some embodiments, the scorer 112a includes a pre-processing module for each scoring module. In some embodiments, each pre-processing module is constructed to process the input variable values into a format suitable for use by the corresponding scoring module. In some embodiments, each pre-processing module is constructed to determine whether to execute the corresponding sub-model based on the input variable values.

In some embodiments, the scorer 112 determines a score using at least one of the following algorithms: a population sampling, unsupervised methods such as principal components analysis, factor analysis, k-means and other clustering analysis, t-sne, latent and quadratic dirichlet allocation, outlier and anomaly detection, supervised classification and regression methods such as decision trees, random forest, gradient boosted trees, neural networks, regularized regression, support vector machines, bayesian classifiers, k-nearest neighbors, Follow the regularized leader, greedy step averaging (GSA), time-decaying adaptive prediction (TDAP), factorization machines, gaussian processes and online learning algorithms.

Decisioning Information Consuming System

In some embodiments, decision information consuming systems include decision information consuming systems for at least one of: loan application underwriting decisions, on-line advertising bidding decisions, autonomous vehicle (e.g., self driving car, aircraft, drone, etc.) decisions, visual avoidance decisions (e.g., for visual avoidance systems of an autonomous vehicle), business decisions, financial transaction decisions, robot control decisions, artificial intelligence decisions, and medical diagnosis systems, and the like. In some embodiments, at least one decision information consuming system (e.g., 130) is constructed to provide configuration information to the modeling system (e.g., 110) and the modeling system is constructed to generate decision information (e.g., a score) for the decision information consuming system based on the configuration information. In some embodiments, the configuration information includes modeling information provided by the decision information consuming system. In some implementations, the configuration information is provided via an API. In some embodiments, the configuration information specifies a use for the decision information. In some embodiments, the configuration information specifies a type of the decision information. In some embodiments, the configuration includes the decisioning criteria, for example, in the form of rules based on a model's output. In some embodiments, the configuration information specifies at least one of: an input data source, a model, and an output destination for the decision information (e.g., a callback URI).

### 2. Methods

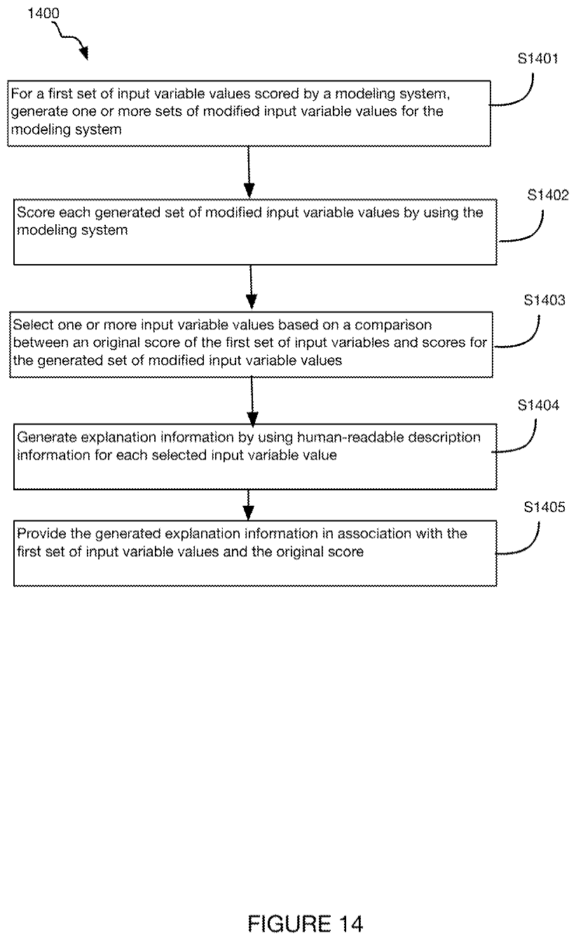

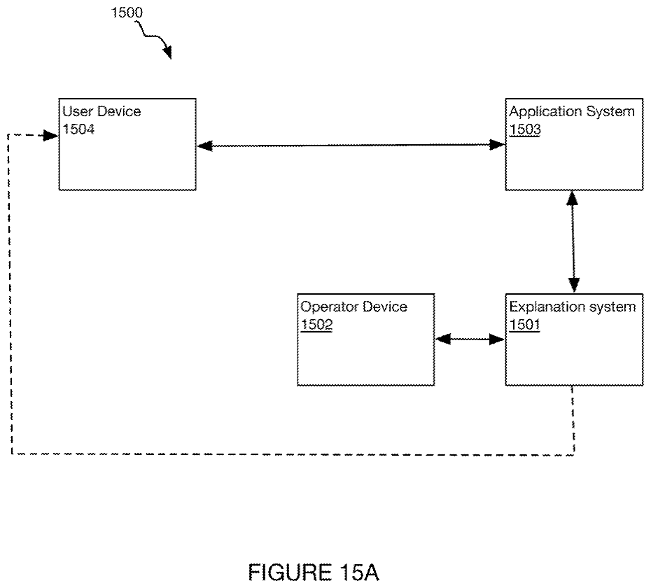

FIG. 14 is a representation of a method, according to embodiments. In some embodiments, the method of FIG. 14 is performed by the explanation generator 190. In some embodiments, the method of FIG. 14 includes: for a first set of input variable values scored by a modeling system (e.g., 110), generating one or more sets of modified input variable values for the modeling system (S1401); scoring each generated set of modified input variable values by using the modeling system (S1402); selecting one or more input variable values based on a comparison between an original score of the first set of input variables and scores for the generated set of modified input variable values (S1403); generating explanation information by using human-readable description information for each selected input variable value (S1404); and providing the generated explanation information in association with the first set of input variable values and the original score (S1405).

In some embodiments the explanation generator 190 compares the scores generated by the modified input variable values to the mean of some subset of input variable values. In some embodiments the explanation generator 190 compares the scores generated by the modified input variable values to a statistical property based on some subset of the input variable values or transformed input variable values. In some embodiments the explanation generator 190 compares the scores generated by the modified input variable values to score ranges for the instant application or applicant. In some embodiments the input variables are modified to cause the maximum possible model score for a given applicant based on a statistical analysis of the distribution of inputs and the outputs as determined, for example, without limitation based on a grid search, gradient descent, or other modeling technique by employing the impactful variable/value identifier 195.

In some embodiments, the modified input value generator 194 performs the process S1401. In some embodiments, the modified input value generator 194 performs the process S1402. In some embodiments, the impactful variable/value identifier 195 performs the process S1403. In some embodiments, the explanation generator 196 performs the process S1404. In some embodiments, the explanation generator 196 performs the process S1405.

Process 1401

In some embodiments, generating one or more sets of modified input variable values for the modeling system includes accessing the first set of input variable values. In some embodiments, generating one or more sets of modified input variable values for the modeling system includes accessing the first set of input variable values from a storage device. In some embodiments, generating one or more sets of modified input variable values for the modeling system includes accessing the first set of input variable values from the modeling system via a modeling system interface (e.g., 193) of the explanation generator. In some embodiments, generating one or more sets of modified input variable values for the modeling system includes accessing the first set of input variable values from the modeling system via an API (e.g., a RESTful API, EDI, CORBA, XMLRPC, and other machine to machine communication methods and programming interfaces) of the modeling system.

In some embodiments, input variables include variables that have values specifying at least one of the following types of data:

Credit bureau data

Credit utilization history

Balances and balance history

Public records

Transactions, including: bank transactions, e-commerce transactions

Browse and search history

Social media data

Loan and collection data

Image, video and audio data

Bank data

Sensor data

Financial market and investment data

Customer relationship management data, including, without limitation, prior credit applications and/or records of customer interactions, such as data related to customer service calls, purchases, payments, and other transactions

Genetic data

Medical records

Utility payment and utilization data

Wearable activity trackers

Telephone and device data

Application utilization data

Residential data such as mortgage and rent amounts

Car ownership status and history

Educational history including GPA, major, and courses attended

Third party testimonials, and references

Letters of introduction

Legal judgments and court transcripts

Device information

GPS data and or other location data and histories

Police records

Unlabeled data

Survey data

In some embodiments, the modified input value generator 194 generates the one or more sets of modified input variable values for the modeling system by generating at least one modified set of input variable values for each variable of the first set of input variable values, wherein each modified set includes the original input variable values with the exception of the modified value for the selected variable. In some embodiments, for each variable of the first set of input variable values, the explanation generator generates a modified set of input variable values for each possible value for the variable, wherein each modified set includes the original input variable values with the exception of the modified value for the selected variable.

In some embodiments, the user performs the selection and mapping process via a structured workflow that presents sequences of screens that prompt the user to evaluate each variable and determine the appropriate transformation. In some embodiments, the selection of the variables and the order of presentation of the variables to be transformed is determined based on the contributions of each variable to the model as determined by statistical methods such as maximum entropy. In some embodiments the structured workflow is comprised of partial dependence plots for each variable.

In some embodiments, the modified input value generator 194 generates the one or more sets of modified input variable values for the modeling system by accessing user selection of a set of variables of the first set of input variables to be modified individually, and generating at least one modified set of input variable values for each variable of the set of selected variables, wherein each modified set includes the original input variable values with the exception of the modified value for the selected variable. In some embodiments, the explanation generator determines a number of modified sets of input variable values to be generated for a selected variable, and variable values of the selected variable for each modified set, based on transformation information. In some embodiments, the transformation information is user-specified transformation information provided by to the explanation generator via an operator device (e.g., 170). In some embodiments, the transformation information is generated by a supervised, unsupervised, or semi-supervised machine learning algorithm.

By virtue of generating modified sets of input variable values based on user selection of a set of variables, a number of modified sets can be reduced, as compared to generating a modified set for each variable. For example, an operator familiar with lending practices might know which variables are most likely to impact a score used for a lending decision. In some embodiments, an explanation creation system 180 provides historical data (variables and corresponding scores previously generated by the modeling system) for display to an operator (via an operator device 170), and the operator uses the displayed historical data to identify variables most likely to impact a score used for a lending decision, and then specify those variables as the user-selection.

In some embodiments, the user reviews each variable and assigns it to a category. In some embodiments, each category is assigned a natural language description. In some embodiments, each variable is assigned a natural language description. In some embodiments, each variable is mapped to a positive or negative slope, valence or classification. In some embodiments, the classification is specified by user input. In some embodiments, the classification is based on an analysis of the input variables and the machine learning model outputs. In some embodiments, such analysis includes machine learning modeling. In some embodiments, categories are computed automatically based on analysis of statistical properties of the input variables and the machine learning model outputs, using at least one of supervised, unsupervised and semi-supervised methods. In some embodiments, each slope, range, band or category is assigned a natural language description.

In some embodiments, the modified input value generator 194 generates the one or more sets of modified input variable values for the modeling system by executing transformation rules represented in a computer programming language. In some embodiments, the modified input value generator 194 generates the one or more sets of modified input variables for the modeling system by transmitting input values to an external system via a communications network and receiving the transformed values. In some embodiments, the external system is a machine learning model.

In some embodiments, the modified input value generator 194 generates the one or more sets of modified input variable values for the modeling system by accessing user selection of a set of groups of variables to be modified in combination with each other, and generating at least one modified set of input variable values for each group of variables of the set of selected groups of variables, wherein each modified set includes the original input variable values with the exception of the modified values for the variable of the selected group. In some embodiments, the explanation generator determines a number of modified sets of input variable values to be generated for a selected group of variables, and variable values for the selected group of variables for each modified set, based on transformation information. In some embodiments, the transformation information is user-specified transformation information provided by to the explanation generator via an operator device (e.g., 170). In some embodiments, the transformation information is determined based on a machine learning modeling process and transmitted to the explanation generator via a computer network.

By virtue of generating modified sets of input variable values based on a selection of a group of variables, a number of modified sets can be reduced, as compared to generating a modified set for each variable individually. For example, an operator familiar with lending practices might know which combinations of variables are most likely to impact a score used for a lending decision. In some embodiments, an explanation creation system 180 provides historical data (variables and corresponding scores previously generated by the modeling system) for display to an operator (via an operator device 170), and the operator uses the displayed historical data to identify combinations of variables most likely to impact a score used for a lending decision, and then specify those combinations of variables as the user-selection.

Process S1402

In some embodiments, the explanation generator 190 scores each generated set of modified input variable values by providing each generated set of modified input variables to the modeling system. In some embodiments, the explanation generator 190 scores each generated set of modified input variable values by providing each generated set of modified input variables to the modeling system via a modeling system interface (e.g., 193). In some embodiments, the explanation generator 190 scores each generated set of modified input variable values by providing each generated set of modified input variables to the modeling system via an API of the modeling system (e.g., a RESTful API, EDI, CORBA, XMLRPC, and other machine to machine communication methods and programming interfaces).

Process S1403

In some embodiments, selecting one or more input variable values includes accessing the original score of the first set of input variables. In some embodiments, selecting one or more input variable values includes accessing the original score of the first set of input variables from a storage device. In some embodiments, selecting one or more input variable values includes accessing the original score of the first set of input variables from the modeling system via a modeling system interface (e.g., 193) of the explanation generator. In some embodiments, selecting one or more input variable values includes accessing the original score of the first set of input variables accessing the first set of input variable values from the modeling system via an API (e.g., a RESTful API. EDI, CORBA, XMLRPC, and other machine to machine communication methods and programming interfaces) of the modeling system.

In some embodiments, selecting one or more input variable values includes accessing the scores for the generated set of modified input variable values. In some embodiments, selecting one or more input variable values includes accessing the scores for the generated set of modified input variable values from a storage device. In some embodiments, selecting one or more input variable values includes accessing the scores for the generated set of modified input variable values from the modeling system via a modeling system interface (e.g., 193) of the explanation generator. In some embodiments, selecting one or more input variable values includes accessing the scores for the generated set of modified input variable values from the modeling system via an API (e.g., a RESTful API, EDI, CORBA, XMLRPC, and other machine to machine communication methods and programming interfaces) of the modeling system.

In some embodiments, identifier 195 selects the one or more input variable values by comparing a modified score with the first score (original score). In some embodiments, if the comparison indicates that the modified score is greater than the first score, and one of the modified score, a corresponding variable, and a corresponding variable value satisfies selection criteria, then the identifier 195 selects the corresponding variable. In some embodiments, the selection criteria is user-specified selection criteria provided by to the explanation generator via an operator device (e.g., 170). In some embodiments, the selection criteria specifies a score increase threshold, and the modified score satisfies the selection criteria if the modified score is greater than the original score by an amount that exceeds the score increase threshold.

In some embodiments, the selection criteria specifies a rank threshold, the identifier 195 ranks variable and value combinations of the modified sets of input variable values in order of corresponding score increases, and selects the top-ranked variable and value combinations having a rank that exceeds the rank threshold.

In some embodiments, the selection criteria are determined based on a statistical algorithm.

Process S1404

In some embodiments, generating explanation information by using human-readable description information for each selected input variable value includes accessing human-readable description information for each selected input variable value. In some embodiments, the description information is included in user-specified description information provided by to the explanation generator via an operator device (e.g., 170). In some embodiments, the description information is included in user-specified description information provided by to the explanation generator via an explanation creation system (e.g., 180).

In some embodiments, the explanation generator (e.g., 190) by generating the explanation information based on the accessed human-readable description information for each selected input variable value.

In some embodiments, the explanation generator (e.g., 190) by generating the explanation information based on the accessed human-readable description information for each selected input variable value by using a natural language processing (NLP) module that is constructed to process the accessed description information to generate the explanation information. In some embodiments, the explanation information indicates a possible or actual cause for the first score generated by the modeling system for the first set of input variable values. In some embodiments, the explanation information indicates actions that can be taken to increase a score generated by the modeling system relative to the first score generated for the first set of input variable values.

Process S1405

In some embodiments, providing the generated explanation information in association with the first set of input variable values and the original score includes the explanation generator providing the explanation information as an explanation for the original score given to the first set of input variable values to a reporting system (e.g., 191). In some embodiments, providing the generated explanation information in association with the first set of input variable values and the original score includes the explanation generator providing the explanation information as an explanation for the original score given to the first set of input variable values to a user device (e.g., 140).

In some embodiments the explanations are generated based on user-assigned categories. In some embodiments the explanations are generated based on machine generated categories such as covariance clusters.

### 3. System Architecture

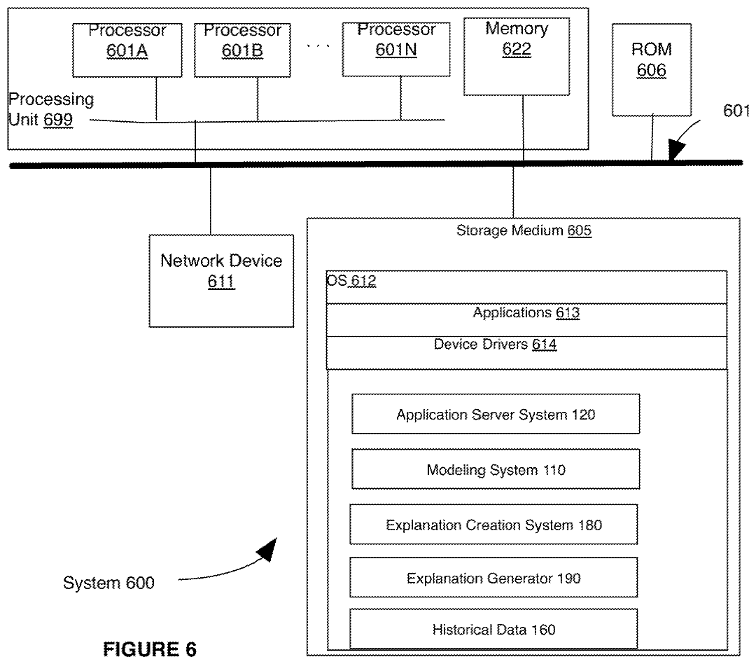

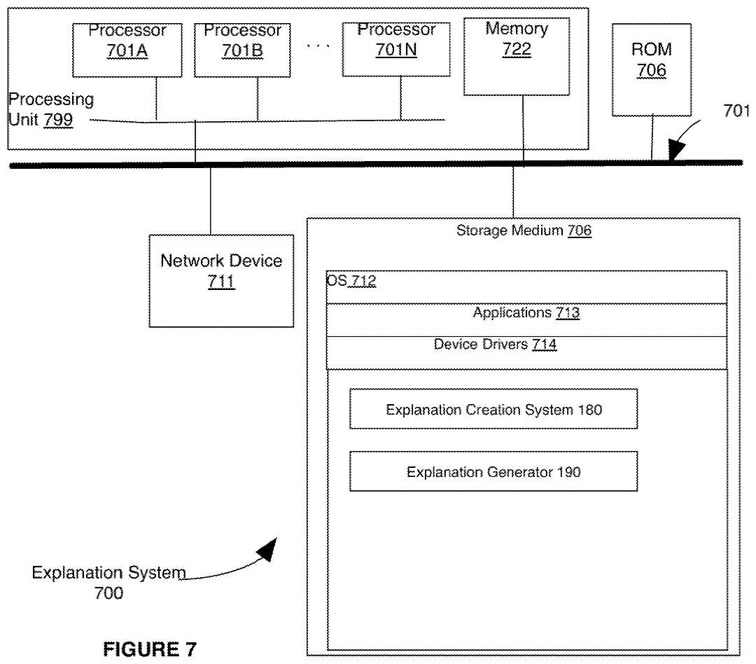

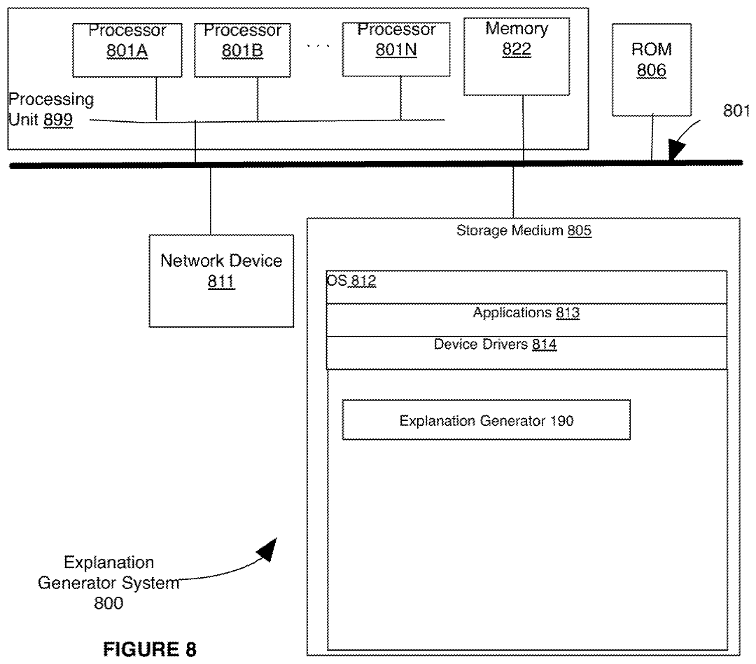

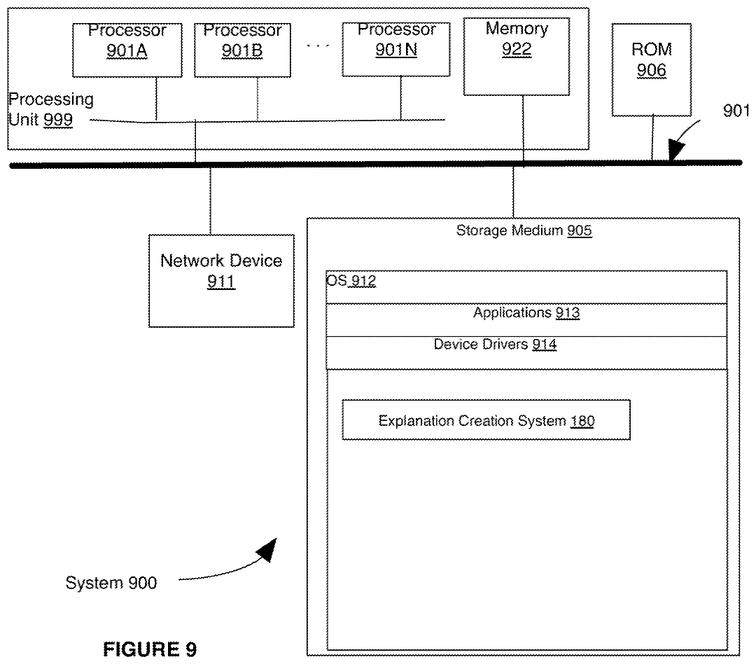

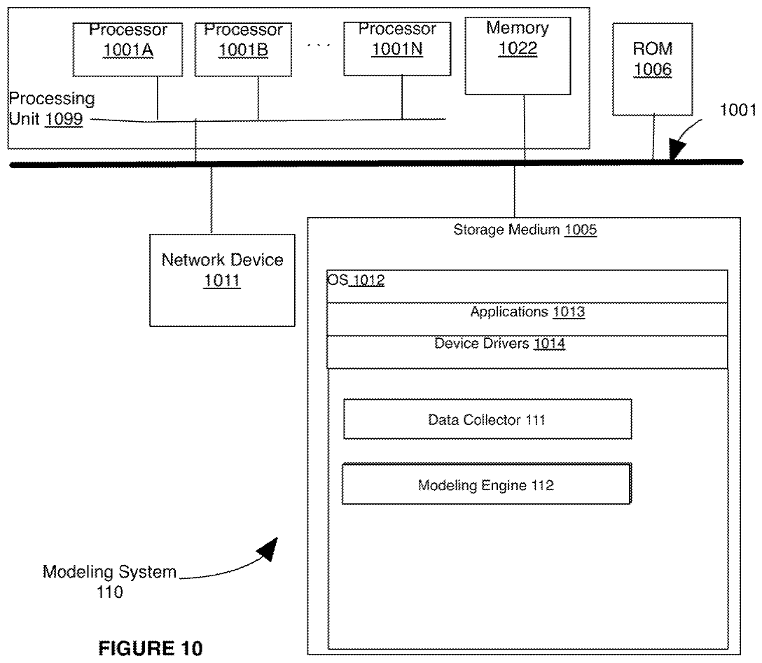

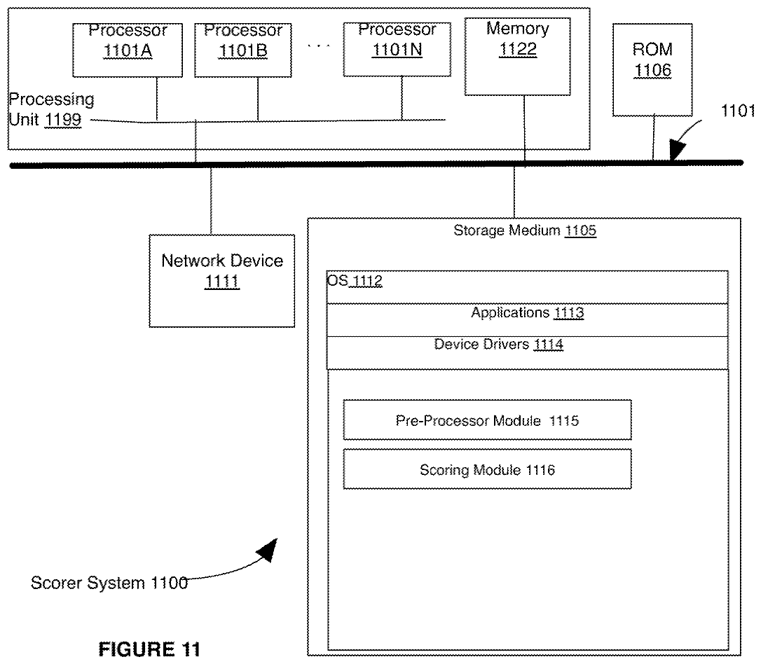

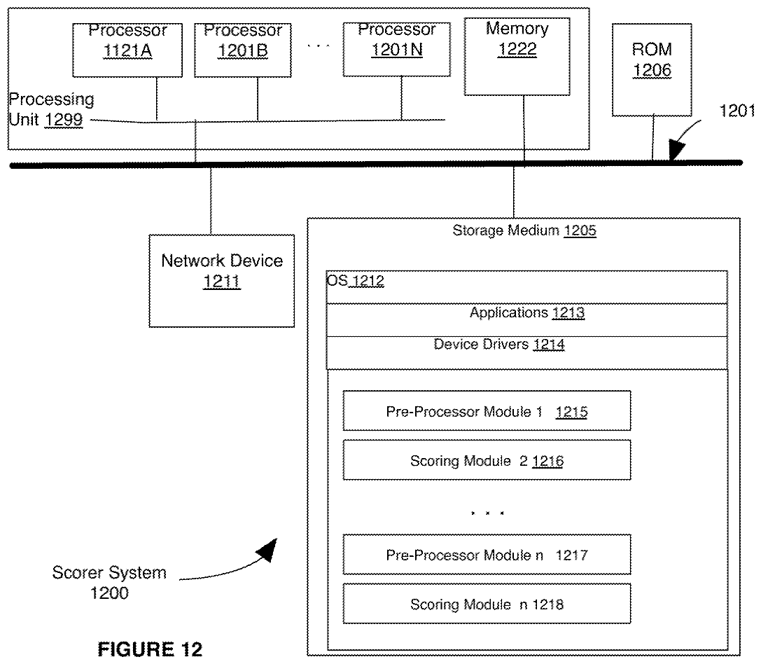

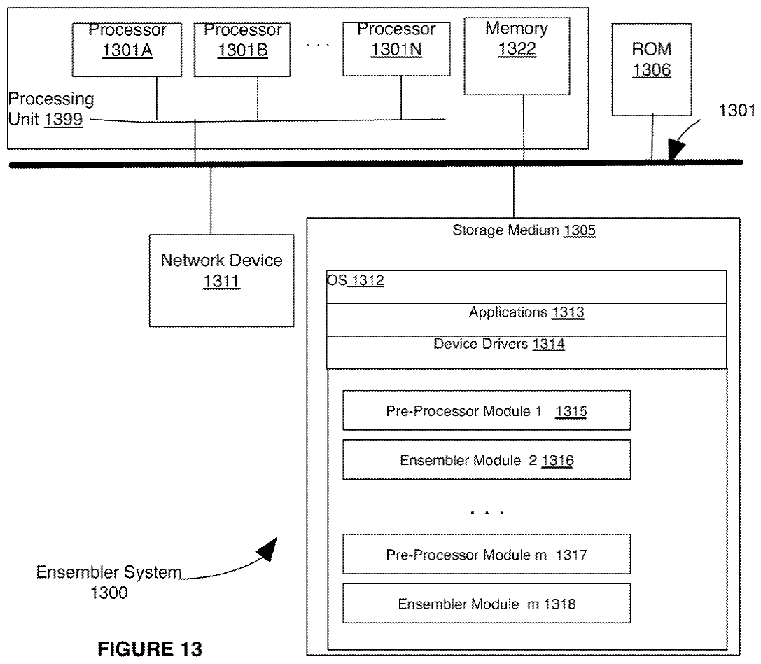

FIG. 6 is a diagram depicting system architecture of a system, according to embodiments. FIG. 7 is a diagram depicting system architecture of an explanation system, according to embodiments. FIG. 8 is a diagram depicting system architecture of an explanation generator system, according to embodiments. FIG. 9 is a diagram depicting system architecture of an explanation creation system, according to embodiments. FIG. 10 is a diagram depicting system architecture of a modeling system, according to embodiments. FIG. 11 is a diagram depicting system architecture of a single scorer system, according to embodiments. In some embodiments, the system of FIG. 11 includes a pre-processor module (e.g., 1115) for the scorer (e.g., 1116). FIG. 12 is a diagram depicting system architecture of an ensembled scorer system having n scoring modules, according to embodiments. In some embodiments, the system of FIG. 12 includes a pre-processor module (e.g., 1215, 1217) for each scorer (e.g., 1216, 1218). FIG. 13 is a diagram depicting system architecture of a ensembler system, according to embodiments. In some embodiments, the system of FIG. 13 includes m ensembler modules (e.g., 1316, 1318) and a pre-processor module (e.g., 1215, 1317) for each ensembler module. In some embodiments, a number (“m”) of ensembler modules is less than a number (“n”) of scoring modules. In some embodiments, a number (“m”) of ensembler modules is equal to a number (“n”) of scoring modules.

In some embodiments, one or more of the systems of FIGS. 6-13 are implemented as a single hardware server device. In some embodiments, one or more of the systems of FIGS. 4-11 are implemented as a plurality of hardware devices.

In some embodiments, each bus (e.g., 601, 701, 801, 901, 1001, 1101, 1201 and 1301) interfaces with the processors, the main memory (e.g., random access memory (RAM) 622, 722, 822, 922, 1022, 1122, 1222, 1322), a read only memory (ROM), a processor-readable storage medium, and a network device. In some embodiments, at least one of a display device and a user input device.

In some embodiments, the processors include one or more of an ARM processor, an X86 processor, a GPU (Graphics Processing Unit), and the like. In some embodiments, at least one of the processors includes at least one arithmetic logic unit (ALU) that supports a SIMD (Single Instruction Multiple Data) system that provides native support for multiply and accumulate operations.

In some embodiments, at least one of a central processing unit (processor), a GPU, and a multi-processor unit (MPU) is included.

The processors and the main memory (e.g., 622, 722, 822, 922, 1022, 1122, 1222, 1322) form a processing unit. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip).

In some embodiments, the processing unit includes at least one arithmetic logic unit (ALU) that supports a SIMD (Single Instruction Multiple Data) system that provides native support for multiply and accumulate operations.

The network adapter device provides one or more wired or wireless interfaces for exchanging data and commands. Such wired and wireless interfaces include, for example, a universal serial bus (USB) interface. Bluetooth interface, Wi-Fi interface, Ethernet interface, near field communication (NFC) interface, and the like.

Machine-executable instructions in software programs (such as an operating system, application programs, and device drivers) are loaded into the memory (of the processing unit) from the processor-readable storage medium, the ROM or any other storage location. During execution of these software programs, the respective machine-executable instructions are accessed by at least one of processors (of the processing unit) via the bus, and then executed by at least one of processors. Data used by the software programs are also stored in the memory, and such data is accessed by at least one of processors during execution of the machine-executable instructions of the software programs. The processor-readable storage medium is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium includes machine-executable instructions (and related data) for an operating system, software programs, and device drivers.

As shown in FIG. 6, the system 600 includes a bus 601, a processing unit 699, a ROM 606, a network device 611, and a storage medium 605. The processing unit 699 includes processors 601A-N. The storage medium 605 includes an operating system 612, applications 613, device drivers 614, the application server system 120, the modelling system 110, the explanation creation system 180, the explanation generator 190, and historical data 160.

As shown in FIG. 7, the system 70) includes a bus 701, a processing unit 799, a storage medium 706 such as a ROM 706, and a network device 711. The processing unit 799 includes processors 701A-N. The storage medium 706 includes an operating system 712, applications 713, device drivers 714, the explanation creation system 180, and the explanation generator 190.

As shown in FIG. 8, the system 800 includes a bus 801, a processing unit 899, a ROM 806, a network device 811, and a storage medium 805. The processing unit 899 includes processors 801A-N. The storage medium 805 includes an operating system 812, applications 813, device drivers 814, and the explanation generator 190.

As shown in FIG. 9, the system 900 includes a bus 901, a processing unit 999, a ROM 906, a network device 911, storage medium 905, and an explanation creation system 180. The processing unit 999 includes processors 901A-N. The storage medium 905 includes an operating system 912, applications 913, device drivers 914, and the explanation creation system 190.

As shown in FIG. 10, the modeling system 110 includes a bus 1001, a processing unit 1099, a ROM 1006, a network device 1011, and a storage medium 1005. The processing unit 1099 includes processors 1001A-N. The storage medium 1005 includes an operating system 1012, applications 1013, device drivers 1014, the data collector 111 and the modelling engine 112.

As shown in FIG. 11, the system 1100 includes a bus 1101, a processing unit 1199, a ROM 1106, a network device 1111, and a storage medium 1105. The processing unit 1199 includes processors 1101A-N. The storage medium 1105 includes an operating system 1112, applications 1113, device drivers 1114, the pre-processor module 1115, and the scoring module 1116.

As shown in FIG. 12, the system 1200 includes a bus 1201, a processing unit 1299, a ROM 1206, a network device 1211, and a storage medium 1205. The processing unit 1299 includes processors 1121A, and 1201B-N. The storage medium 1205 includes an operating system 1212, applications 1213, device drivers 1214, the pre-processor modules 1215 and 1217, and the scoring modules 1216 and 1218.

As shown in FIG. 13, the system 1300 includes a bus 1301, a processing unit 1399, a ROM 1306, a network device 1311, and a storage medium 1305. The processing unit 1399 includes processors 1301A-N. The storage medium 1305 includes an operating system 1312, applications 1313, device drivers 1314, the pre-processor modules 1315 and 1317, and the ensembler modules 1316 and 1318.

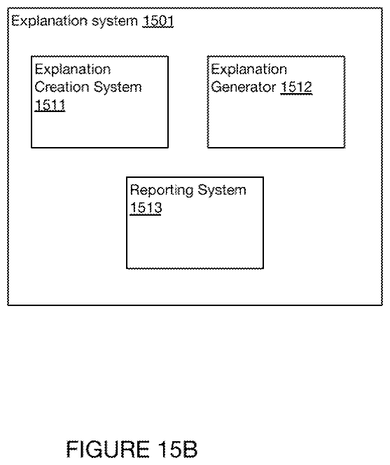

### 4. FIGS. 15A-B

FIGS. 15A-B are schematic representations of systems, according to embodiments. In some embodiments, the system 1500 includes an explanation system 1501 that communicatively coupled to an application system 1503.

In some embodiments, the application system 1503 is a score generation system that is constructed to generate a score for an input data set based on historical data. In some embodiments, the score generation system is constructed to generate the score by using a machine-learning model that is constructed using the historical data. In some embodiments, the machine-learning model is trained using the historical data. In some embodiments, the machine-learning model is validated using the historical data. In some embodiments, the score is a numerical value. In some embodiments, the score is a continuous value.

In some embodiments, the application system 1503 is a decision generation system that is constructed to generate a decision value for an input data set based on historical data. In some embodiments, the decision value is a discrete value. In some embodiments, the decision value is a binary value. In some embodiments, the decision value is a value selected from a set of discrete values. In some embodiments, the decision generation system includes a score generation system. In some embodiments, the decision generation system is constructed to generate the decision value by using a machine-learning model that is constructed using the historical data. In some embodiments, the machine-learning model is trained using the historical data. In some embodiments, the machine-learning model is validated using the historical data. In some embodiments, the decision value is a numerical value. In some embodiments, the decision value is a continuous value.

In some embodiments, the application system 1503 includes at least one of a decision generation system and a score generation system. In some embodiments, the application system 1503 is constructed to communicatively couple to at least one user device 1504. In some embodiments, the application system 1503 is similar to the modeling system 110 of FIG. 1. In some embodiments, the application system 1503 is similar to the decision information consuming system 130 of FIG. 1. In some embodiments, the application system 1503 includes an application server. In some embodiments, the application system 1503 is similar to the application server 120 of FIG. 1. In some embodiments, the application system 1503 includes one or more of the application server 120, the modeling system 110, the decision information consuming system 130 of FIG. 1.

In some embodiments, the explanation system 1501 is constructed to communicatively couple to at least one user device 1504.

In some embodiments, the explanation system 1501 includes an explanation creation system 1511. In some embodiments, the explanation system 1501 includes an explanation generator 1512. In some embodiments, the explanation system 1501 includes a reporting system 1513. In some embodiments, the explanation creation system 1511 is similar to the explanation creation system 180. In some embodiments, the explanation generator 1512 is similar to the explanation generator 190. In some embodiments, the reporting system 1513 is similar to the reporting system 190.

In some embodiments, the operator device 1502 is similar to the operator device 170. In some embodiments, the user device 1504 is similar to the user device 140 of FIG. 1.

### 5. Figure

In some embodiments, a method 1600 includes: the explanation system 1501 generating explanation configuration information based on user input received from an operator device (e.g., 1502) (process S1610); the explanation system 1501 receiving a first explanation request from a first application system (process S1620); the explanation system 1501 generating a plurality of modified input variable value sets for a first applicant by using data of the first explanation request and the explanation configuration information (process S1630); for each modified input variable value set, the explanation system 1501: providing a request to the first application system by using a first callback specified by the first explanation request, and receiving a result for the modified input variable value set from the first application system as a response to the request (process S1640); the explanation system 1501 selecting at least one input variable value based on a comparison between a first result of a first input variable value set of the first applicant and results for the modified input variable value sets, by using the explanation configuration information (process S1650); and the explanation system 1501 generating explanation information for the first result by using human-readable description information for each selected input variable value, in accordance with the explanation configuration information (process S1660).

In some embodiments, for each modified input variable value set, the result is a score generated by a score generation system of the first application system. In some embodiments, for each modified input variable value set, the result is a decision value generated by a decision generation system of the first application system.

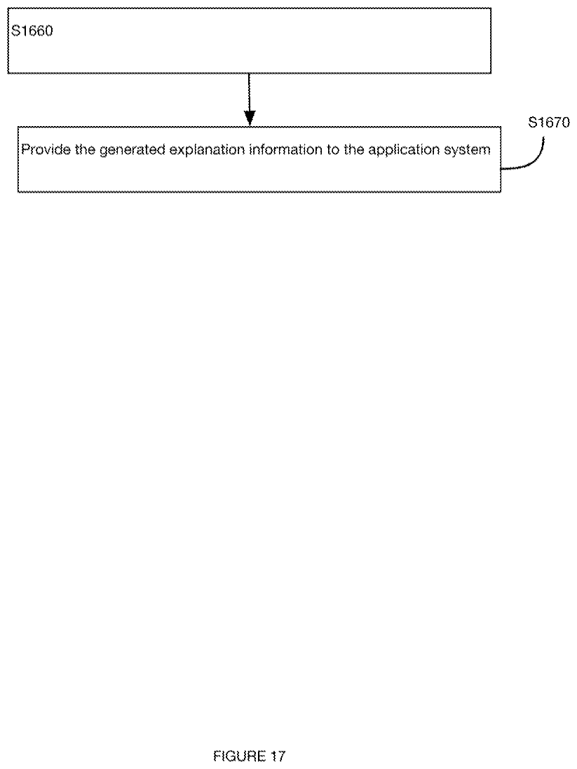

In some embodiments, the method 1600 includes: the explanation system 1501 providing the generated explanation information to the application system 1503 (process S1670 of FIG. 17). In some embodiments, the explanation system 1501 provides the generated explanation information to the application system 1503 by using the first callback. In some embodiments, the explanation system 1501 provides the generated explanation information to the application system 1503 by using a second callback of the first score explanation request.

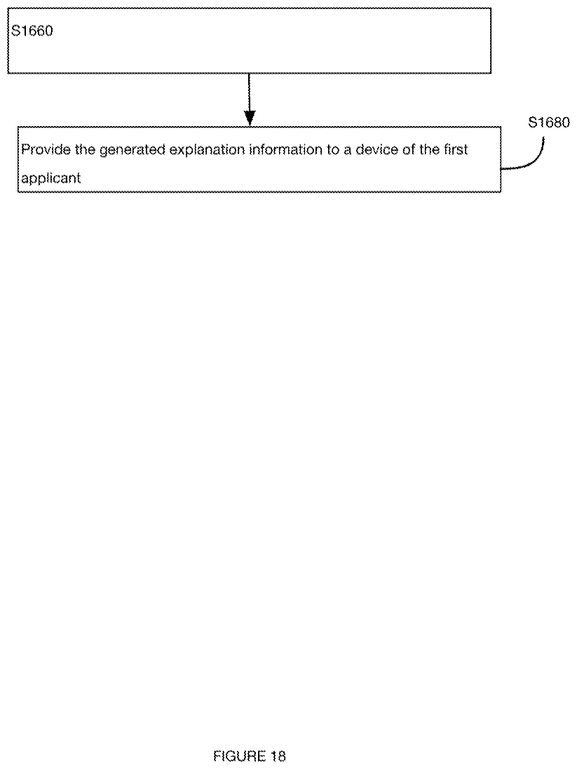

In some embodiments, the method 160) includes: the explanation system 1501 providing the generated explanation information to a device of the first applicant (e.g., the user device 1504) based on information of the first explanation request (process S1680 of FIG. 18).

In some embodiments, the explanation system 1501 generates modified input variable value sets as described herein for the process S1401 of FIG. 14.

In some embodiments, the explanation system 1501 selects input variable values as described herein for the process S1403 of FIG. 14.

In some embodiments, the explanation system 1501 generates explanation information as described herein for the process S1404 of FIG. 14.

In some embodiments, the explanation configuration information is generated prior to receiving the first explanation request.

In some embodiments, the explanation system 1501 stores the generated explanation configuration information.

In some embodiments, the first explanation request specifics the first result and the first input variable value set for the first applicant.

In some embodiments, the user input includes user user-selection of salient variables, user-specified transformation information, user-specified impactful variable selection criteria, and user-specified human-readable description information for selected variables.

In some embodiments, the explanation system 1501 receives the first explanation request from the first application system via an API of the explanation system.

In some embodiments, the explanation system 1501 receives user input from the first operator device via an API of the explanation system. In some embodiments, the explanation system 1501 receives user input from the first operator device via a user interface module of the explanation system.

In some embodiments, the first application system uses a first model to generate each generated result by using financial data of the first applicant and non-financial data of the first applicant. In some embodiments, the non-financial data of the first applicant includes at least one of: social media data, search history data, browsing data, telephone and device data, application utilization data, educational history data, GPS data, device information, and sensor data.

In some embodiments, the method 1600 includes: the first application system generating first applicant denial information for the first applicant by using the first result for the first input variable value set of the first applicant; responsive to generation of first applicant denial information, the first application system providing the first explanation request to the explanation system, wherein the explanation information for the first result includes an explanation for denial of an application of the first applicant.

In some embodiments, the method 1600 includes: the explanation system providing the generated explanation information to the first application system by using the first callback; the first application system receiving the generated explanation information; and the first application system providing the generated explanation information to an applicant device of the first applicant.

In some embodiments, the method 1600 includes: the first application system receiving a first application request from the applicant device (e.g., 1504), wherein the first application system provides the generated explanation information to the applicant device as a response to the first application request. In some embodiments, the method 1600 includes: the first application system receiving a first application request from the applicant device via a user interface module of the first application system, wherein the first application system provides the generated explanation information to the applicant device as a response to the first application request via the user interface module. In some embodiments, the user interface module of the first application system includes an application server, and wherein the first application system is communicatively coupled to the first applicant device via the Internet. In some embodiments, wherein the first application request is a request for approval of a loan application of the first applicant.

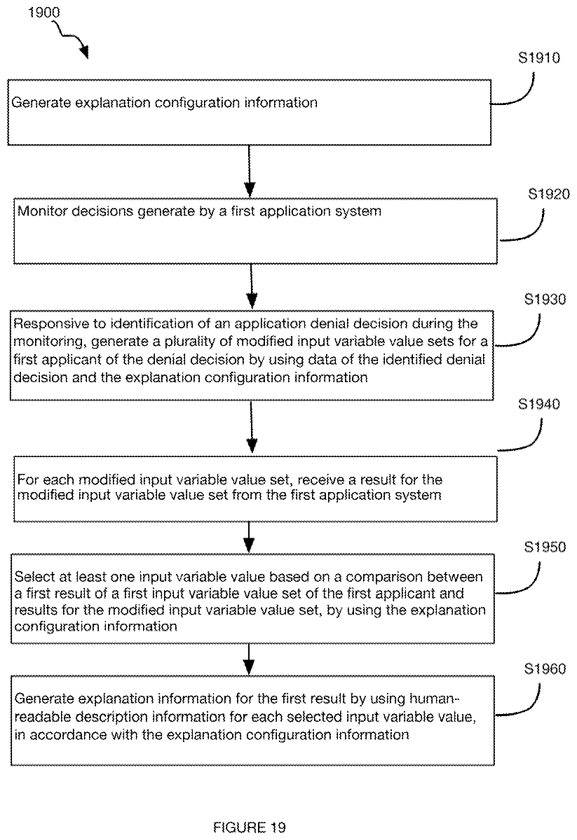

### 6. FIG. 19

In some embodiments, a method 1900 (FIG. 19) includes: the explanation system 1501 generating explanation configuration information based on user input received from an operator device (e.g., 1502) (process S1910); the explanation system 1501 monitoring decisions generated by a first application system via an API of the first application system (e.g., 1503 of FIG. 15A) to identify denial decisions generated by the first application system (process S1920); responsive to identification of an application denial decision during the monitoring, the explanation system 1501 generating a plurality of modified input variable value sets for a first applicant of the denial decision by using data of the identified denial decision and the explanation configuration information (process S1930); for each modified input variable value set, the explanation system 1501: providing a request to the first application system by using the API of the first application system, and receiving a result for the modified input variable value set from the first application system as a response to the request (process S1940); the explanation system 1501 selecting at least one input variable value based on a comparison between the denial decision of a first input variable value set of the first applicant and results for the modified input variable value sets, by using the explanation configuration information (process S1950); and the explanation system 1501 generating explanation information for the denial decision by using human-readable description information for each selected input variable value, in accordance with the explanation configuration information (process S1960).

In some embodiments, the method 1900 includes: the explanation system 1501 providing the generated explanation information to the first application system. In some embodiments, the explanation system 1501 provides the generated explanation information to the first application system by using the API of the first application system.

In some embodiments, the method 1900 includes: the explanation system 1501 providing the generated explanation information to a device of the first applicant (e.g., the user device 1504) based on information of the identified denial decision.

In some embodiments, the explanation system accesses the first input variable value set during the identification of the first denial decision.

In some embodiments, the explanation system accesses contact information of the first applicant during the identification of the first denial decision, and the explanation system 1501 provides the generated explanation information to a device of the first applicant (e.g., the user device 1504) based on the assessed contact information.

In some embodiments, the explanation system 1501 generates modified input variable value sets as described herein for the process S1401 of FIG. 14.

In some embodiments, the explanation system 1501 selects input variable values as described herein for the process S1403 of FIG. 14.

In some embodiments, the explanation system 1501 generates explanation information as described herein for the process S1404 of FIG. 14.

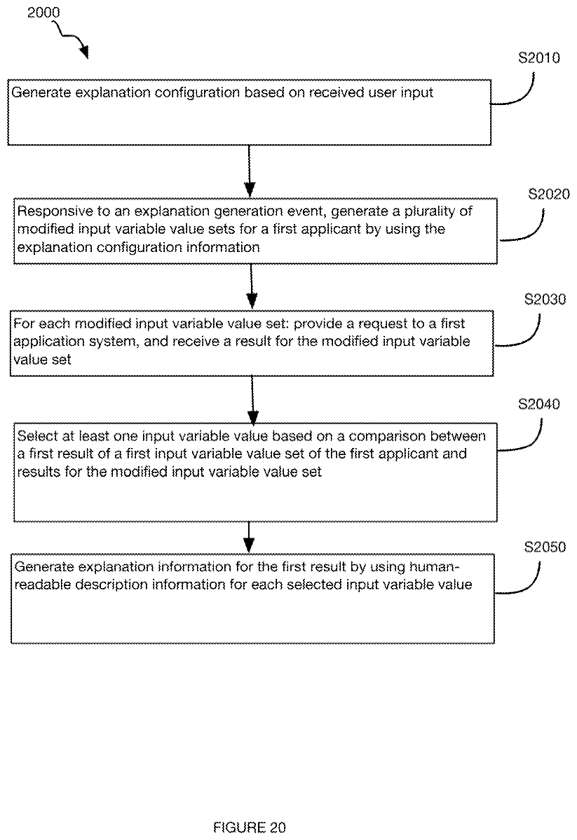

### 7. FIG. 20

In some embodiments, a method 2000 (FIG. 20) includes: generating explanation configuration information based on received user input (process S2010); responsive to an explanation generation event, generating a plurality of modified input variable value sets for a first applicant by using the explanation configuration information (process S2020); for each modified input variable value set: providing a request to a first application system of the explanation generation event for generation of a result for the modified input variable value set, and receiving a result for the modified input variable value set from the application system as a response to the request (process S2030); selecting at least one input variable value based on a comparison between a first result of a first input variable value set of the first applicant and results for the modified input variable value set (process S2040); and generating explanation information for the first result by using human-readable description information for each selected input variable value (process S2050).

In some embodiments, selecting at least one input variable value (the process S2040) includes: selecting at least one input variable value based on a comparison between a first result of a first input variable value set of the first applicant and results for the modified input variable value set, by using the explanation configuration information.

In some embodiments, generating explanation information for the first result (the process S2050) includes: generating explanation information for the first result by using human-readable description information for each selected input variable value, in accordance with the explanation configuration information.

In some embodiments, the method 2000 includes: selecting at least one input variable based on a comparison between a first result of a first input variable value set of the first applicant and results for the modified input variable value set; and generating explanation information for the first result by using human-readable description information for each selected input variable. In some embodiments, input variable values are selected by using the explanation configuration information. In some embodiments, the explanation information is generated in accordance with the explanation configuration information.

In some embodiments, rather than select input variable values, input variables are selected, and explanation information is generated for each selected input variable, rather than for variable values.

In some embodiments, the method 2000 includes: the explanation system 1501 providing the generated explanation information to the first application system. In some embodiments, the explanation system 1501 provides the generated explanation information to the first application system by using an API of the first application system.

In some embodiments, the method 2000 includes: the explanation system 1501 providing the generated explanation information to a device of the first applicant (e.g., the user device 1504) based on information of the explanation generation event.

In some embodiments, the explanation system accesses the first result and the first input variable value set responsive to the explanation generation event. In some embodiments, the first application system provides the first result and the first input variable value set to the explanation system via an API of the explanation system. In some embodiments, the explanation system requests the first result and the first input variable value set from the first application system via an API of the first application system.

In some embodiments, the explanation system accesses contact information of the first applicant responsive to the explanation generation event, and the explanation system 1501 provides the generated explanation information to a device of the first applicant (e.g., the user device 1504) based on the assessed contact information.

In some embodiments, the explanation system 1501 generates modified input variable value sets as described herein for the process S1401 of FIG. 14.

In some embodiments, the explanation system 1501 selects input variable values as described herein for the process S1403 of FIG. 14.

In some embodiments, the explanation system 1501 generates explanation information as described herein for the process S1404 of FIG. 14.

In some embodiments, the method 2000 is performed by an explanation system. In some embodiments, the method 2000 is performed by the explanation system 1501. In some embodiments, the user input is received from an operator device (e.g., 1502). In some embodiments, the explanation generation event is reception of a first explanation request from a first application system. In some embodiments, the explanation generation event is identification of a denial decision generated by a first application system.

In some embodiments, the method 2000 includes providing the generated explanation information to the application system. In some embodiments, the method 2000 includes providing the generated explanation information to a user device of the first applicant.

In some embodiments, for each modified input variable value set, the result is a score generated by a score generation system of the first application system. In some embodiments, for each modified input variable value set, the result is a decision value generated by a decision generation system of the first application system.

In some embodiments, the first result is a score generated by a score generation system of the first application system. In some embodiments, the first result is a decision value generated by a decision generation system of the first application system.

### 8. Explanation Configuration

In some embodiments, the explanation configuration information specifies a subset of all possible variables of an input variable set used by the first application system. In some embodiments, for at least one variable of the set of all possible variables of the an input variable set used by the first application system, the explanation configuration information specifies a subset of all possible variable values of the variable used by the first application system. In some embodiments, the explanation configuration information specifies at least one group of variables of an input variable set used by the first application system wherein each group of variables includes variables to modified in combination with each other to generate a modified input variable value set.

In some embodiments, the explanation configuration information specifies natural language descriptions for categories of variables of the set of all possible variables of the an input variable set used by the first application system. In some embodiments, for at least one variable of the set of all possible variables of an input variable set used by the first application system, the explanation configuration information specifies natural language descriptions for categories of variables values of the set of all possible variables of the variable used by the first application system. In some embodiments, the configuration information specifies selection criteria for selecting impactful variables. In some embodiments, for at least one variable, the configuration information specifies selection criteria for selecting impactful variable values.

In some embodiments, the explanation configuration information is generated as described herein with respect to the explanation creation system 180 of FIG. 1.

In some embodiments, the explanation configuration information is generated based on user input. In some embodiments, the user input includes at least one of user-selection of variables, user-selection of variable values for at least one specified variable, user-selection of variable combinations, user-specified transformation information, user-specified impactful variable selection criteria, user-specified impactful variable value selection criteria for at least one specified variable, user-specified human-readable description information for at least one variable, and user-specified human-readable description information for at least one variable value for a specified variable. In some embodiments, the user input is received from an operator device (e.g., 170, 1504)

### 9. Reduction of Search Space

By virtue of generating a plurality of modified input variable value sets by using the explanation configuration information, a number of modified sets can be reduced, as compared to generating a modified set for each variable. For example, an operator familiar with lending practices might know which variables are most likely to impact a score used for a lending decision. In some embodiments, an operator uses historical data to identify variables most likely to impact a score or decision used for a lending decision, and then specify those variables as the user-selection that is used to generate the explanation configuration information.

In some embodiments, the user input specifies at least one transformation, the transformation is included in the explanation configuration information, and the explanation system uses the transformation to generate the plurality of modified input variable values.

### 10. Commercial Application

In this manner, performance and efficiency can be improved as compared to systems that generate every possible combination of input variable value sets to generate explanation information.

In this manner, explanation information can be generated more quickly, as compared to systems that generate every possible combination of input variable value sets to generate explanation information, and therefore systems and methods described herein can provide explanation information in real-time with respect to a denial decision generated by an application system.

For example, an application system that generates real-time loan application decisions via an on-line loan-application (provided by, for example, a web based application, or a native mobile application) can provide loan denial explanation information at the time of loan denial.

For example, an on-line shopping application that makes real-time credit approval decisions for purchases via an on-line loan-application (provided by, for example, a web based application, or a native mobile application) can provide credit denial explanation information at the time of credit denial or at the time of purchase of a product or service.

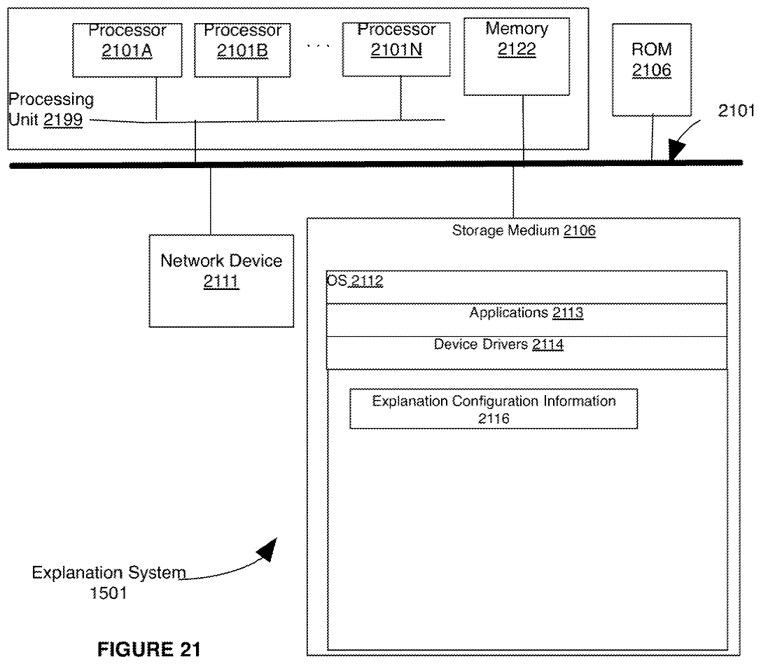

### 11. FIG. 21

FIG. 21 is a diagram depicting system architecture of an explanation system, according to embodiments.

In some embodiments, the system of FIG. 21 is implemented as a single hardware server device. In some embodiments, the system of FIG. 21 is implemented as a plurality of hardware devices.

In some embodiments, the bus 2101 interfaces with the processors 2101A-N, the main memory 2122 (e.g., a random access memory (RAM)), a read only memory (ROM) 2106, a processor-readable storage medium 2105, and a network device 2111. In some embodiments, bus 2101 interfaces with at least one of a display device and a user input device.

In some embodiments, the processors include one or more of an ARM processor, an X86 processor, a GPU (Graphics Processing Unit), and the like. In some embodiments, at least one of the processors includes at least one arithmetic logic unit (ALU) that supports a SIMI) (Single Instruction Multiple Data) system that provides native support for multiply and accumulate operations.

In some embodiments, at least one of a central processing unit (processor), a GPU, and a multi-processor unit (MPU) is included.

In some embodiments, the processors and the main memory 2122 form a processing unit 2199. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip).

In some embodiments, the processing unit includes at least one arithmetic logic unit (ALU) that supports a SIMD (Single Instruction Multiple Data) system that provides native support for multiply and accumulate operations. In some embodiments the processing unit is a Central Processing Unit such as an Intel Xeon processor. In other embodiments, the processing unit includes a Graphical Processing Unit such as NVIDIA Tesla.

The network adapter device 2111 provides one or more wired or wireless interfaces for exchanging data and commands. Such wired and wireless interfaces include, for example, a universal serial bus (USB) interface, Bluetooth interface, Wi-Fi interface, Ethernet interface, near field communication (NFC) interface, and the like.

Machine-executable instructions in software programs (such as an operating system, application programs, and device drivers) are loaded into the memory (of the processing unit) from the processor-readable storage medium, the ROM or any other storage location. During execution of these software programs, the respective machine-executable instructions are accessed by at least one of processors (of the processing unit) via the bus, and then executed by at least one of processors. Data used by the software programs are also stored in the memory, and such data is accessed by at least one of processors during execution of the machine-executable instructions of the software programs.

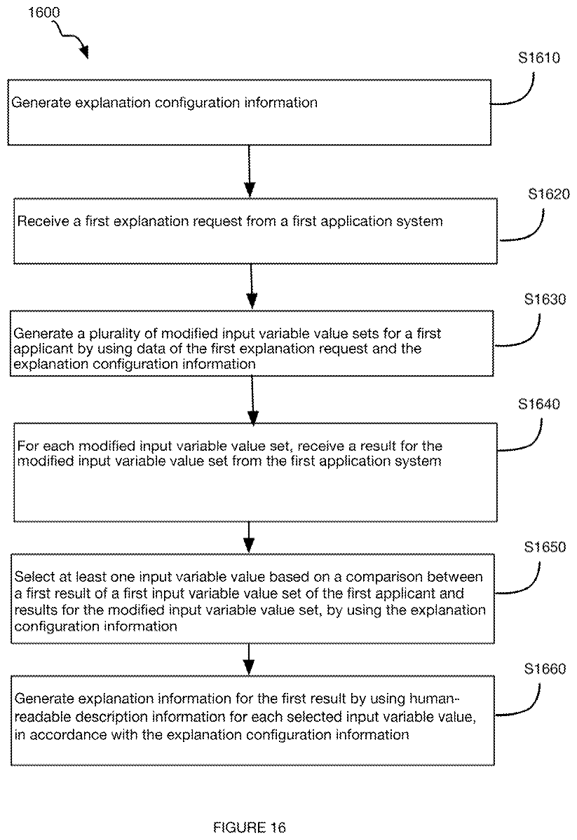

The processor-readable storage medium 2105 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 2105 includes machine-executable instructions (and related data) for an operating system 2112, software programs 2113, device drivers 2114, explanation configuration information 2116, and machine-executable instructions for one or more of the processes of FIGS. 14, and 16-20.

### 12. Machine

The systems and methods of some embodiments and variations thereof can be embodied and/or implemented at least in part as a machine configured to receive a computer-readable medium storing computer-readable instructions. The instructions are preferably executed by computer-executable components. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

### 13. Conclusion

As a person skilled in the art will recognize from the previous detailed description and from the figures and claims, modifications and changes can be made to the embodiments disclosed herein without departing from the scope defined in the claims.

What is claimed is:

1. A computer-based method for explaining a score generated by a machine learning model, the method comprising:
accessing an applicant score from the machine learning modeling system based on a plurality of applicant input variables;
modifying the plurality of applicant input variables to create a plurality of modified input variables;
receiving a modified score from the machine learning modeling system based on the plurality of modified input variables;
generating explanation information based on the plurality of applicant input variables, the applicant score and the modified score; and
transmitting the explanation information to a reporting system.

2. The method of claim 1, wherein modifying the plurality of applicant input variables includes substituting a predetermined value for each of the plurality of applicant input variables.

3. The method of claim 2, further comprising calculating the predetermined value based on a statistical function using the values for a population of loan applicants.

4. The method of claim 3, wherein the statistical function includes a mean.

5. The method of claim 2, wherein the predetermined value is based on a sample of values for a population of loan applicants.

6. The method of claim 2, wherein receiving the modified score includes receiving a plurality of modified scores for a plurality of modified inputs.

7. The method of claim 6, wherein generating the explanation information includes:
comparing each member of the plurality of modified scores with the applicant score; and
determining a rank order of importance for each variable in the plurality of applicant input variables based on the comparison.

8. The method of claim 7, wherein the explanation information includes a human-readable statement explaining a loan denial based on the comparisons.

9. The method of claim 8, wherein the human-readable statement is based on the rank order of importance.

10. The method of claim 9, wherein the human-readable statement is generated by retrieving a predetermined template including a portion of the human-readable statement and a variable name.

11. The method of claim 6, wherein generating the explanation information includes:
grouping a first plurality of members of the plurality of modified scores to form a first group score;
grouping a second different plurality of members of the plurality of modified scores to form a second group score;
comparing the first group score to the applicant score to produce a first differences score;
comparing the second group score to the applicant score to produce a second differences score;
comparing the first differences score to the second differences score; and
determining a rank order of importance for each grouping based on the comparison of the first differences score to the second differences score.

12. The method of claim 11, wherein grouping the first plurality of members is selected via a user interface.

13. The method of claim 1, wherein generating explanation information is further based on the modified input variables.

14. The method of claim 1, further comprising generating a partial dependence plot based on the plurality of modified input variables, wherein the explanation information includes the partial dependence plot.
